(19) United States
(12) Patent Application Publication
(10) Pub. No.: US 2026/0194968 A1
(43) Pub. Date: Jul. 9, 2026

(54) METHODS FOR IDENTIFYING DEVOLVED SEQUENCES OF TYPED INPUT MOTIONS AND ADAPTING A USER'S INPUT SPACE BASED THEREON, AND DEVICES AND SYSTEMS THEREFOR

(71) Applicant: Meta Platforms Technologies, LLC, Menlo Park, CA (US)

(72) Inventors: Rishi Rajalingham, Brooklyn, NY (US); Wei Lwun Lu, Mountain View, CA (US); Nikhil Nagraj Rao, Sunnyvale, CA (US); Niru Nahesh, Menlo Park, CA (US); David Sussillo, Portola Valley, CA (US)

(21) Appl. No.: 19/438,414

(22) Filed: Dec. 31, 2025

Related U.S. Application Data
(60) Provisional application No. 63/741,792, filed on Jan. 3, 2025.

(51) Int. Cl. G06F 3/01; G06F 3/023

(52) U.S. Cl. CPC G06F 3/011; G06F 3/017; G06F 3/0237

(57) ABSTRACT

A method of identifying devolved typing sequences is described. The method includes obtaining, via sensors of a wearable device of a computing system, data corresponding to a user attempting to perform a sequence of typing input motions associated with one or more target inputs while wearing the wearable device. The method includes identifying, based on (i) the data corresponding to the user attempting to perform the sequence of typing input motion and (ii) the target inputs associated with the sequence of typing input motions, a devolved sequence of typed input motions to suggest to the user for inputting a respective target input of the one or more target inputs. The devolved sequence of typed input motions is a different sequence and includes fewer typing input motions as compared to the sequence of typing input motions. And the method includes presenting a representation of the devolved sequence of typed input motions.

### RELATED APPLICATIONS

This application claim priority to U.S. Prov. App. No. 63/741,792, filed on January 3, 2025, entitled “Methods for Identifying Devolved Sequences of Typed Input Motions and Adapting a User’s Input Space Based Thereon, and Devices and Systems therefor,” which is hereby incorporated by reference in its entirety.

### TECHNICAL FIELD

The present disclosure relates generally to wearable electronic devices (e.g., wrist-wearable devices and/or head-wearable devices), and more particularly to wearable electronic devices with sensors for detecting typing input motions (e.g., finger presses, such as keystrokes) performed by a wearer of the wearable device.

### SUMMARY

The methods, devices, and systems described herein address the deficiencies described above. Namely, the techniques described herein allow users to produce one or more target inputs (e.g., textual characters, emojis, reactions) by performing devolved sequences of typing input motions that are suggested to them by a co-adapted machine-learning model. For example, a user may perform one or more typing input motions to produce (e.g., in a text message) letters in the word “this” (e.g., separately typing keystrokes corresponding to “t,” “h,” “i,” and “s”). A machine-learning model receiving data corresponding to the user’s hand movements may determine a simpler “devolved” version of the sequence of typing input motions that the user can perform to produce the same textual elements. As described herein, a devolved version of a sequence of typing input motions can mean that the sequence of input motions requires, for example, less motor activity, is less constrained by legibility criteria, and/or reduces a total number of typing inputs that the user must perform. The devolved sequence of typed input motions may be selected based on an objective of the machine-learning model to improve the user’s speed of producing target inputs (e.g., words per minute).

A first example method of identifying devolved sequences of typing input motions is described herein. The operations of the example method include obtaining, via one or more sensors of a wearable device of a computing system, data corresponding to a user attempting to perform a sequence of typing input motions associated with one or more target inputs while wearing a wearable electronic device of a computing system. The method further includes identifying, based on at least (i) the data corresponding to the user attempting to perform the sequence of typing input motions, and (ii) the one or more target inputs associated with the sequence of typing input motions, a devolved sequence of typed input motions to suggest to the user for inputting a respective target input of the one or more target inputs. The devolved sequence of typed input motions is a different sequence as compared to the sequence of typing input motions, and includes fewer typing input motions as compared to the sequence of typing input motions. And the method includes causing presentation, via the computing system, of a representation of the devolved sequence of typed input motions.

Some of the embodiments of the first example described herein are technical improvements to the physical typing / button pressing methodology for producing text. For example, devolvement criteria for identifying devolved sequences of typing input motions are based on removing aspects of typing input that are based on a legibility constraint (e.g., formal and informal rules about how typing input motions must be provided to be recognized at physical keyboards and/or handheld controllers) which are not necessary for a co-adapted input detection model to identify the same target inputs.

A second example method of presenting representations of identified sequences of typing input motions to a user by applying the sequences of typing input motions to a generative model that is co-adapted to a user of the computing system is provided. The second example includes obtaining, via one or more sensors of a wearable device of a computing system, data corresponding to a user attempting to perform a sequence of typing input motions associated with one or more target inputs while wearing the wearable electronic device of a computing system. The second example method includes identifying, based on at least (i) the data corresponding to the user attempting to perform the sequence of typing input motions and (ii) the one or more target inputs associated with the sequence of typing input motions, a devolved sequence of typed input motions to suggest to the user for inputting a respective target input of the one or more target inputs, where the devolved sequence of typed input motions is a different sequence as compared to the sequence of typing input motions, and includes fewer typing input motions as compared to the sequence of typing input motions. The second example method includes, after identifying the devolved sequence of typed input motions, providing information about the devolved sequence of typed input motions to a generative model. The second example method includes receiving, from the generative model, a representation of the devolved sequence of typed input motions. And the second example method includes causing presentation, via the computing system, of the representation of the devolved sequence of typed input motions received from the generative model.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will not be presented.

### BRIEF DESCRIPTION OF THE DRAWINGS

For a better understanding of the various described embodiments, reference should now be made to the detailed description below, in conjunction with the following drawings in which like reference numerals refer to corresponding parts throughout the figures.

FIGS. 1A to 1H illustrate an example artificial-reality (AR) system for determining target inputs based on sequences of typing input motions performed by a user and identifying devolved sequences of typing input motions, in accordance with some embodiments.

FIGS. 2A to 2C show an example method flow chart for identifying devolved sequences of typing input motions for generating target inputs using a co-adapted input detection model, in accordance with some embodiments.

FIGS. 3A, 3B, 3C-1, and 3C-2 illustrate example AR systems, in accordance with some embodiments.

In accordance with customary practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with distinct types or embodiments of AR systems. AR, as described herein, is any superimposed functionality and/or sensory-detectable presentation provided by an AR system within a user’s physical surroundings. Such ARs can include and/or represent virtual reality (VR), augmented reality, mixed AR (MAR), or some combination and/or variation of these. For example, a user can perform a swiping in-air hand gesture to cause a song to be skipped by a song-providing application programming interface (API) providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

AR content can include completely generated content or generated content combined with captured (e.g., real-world) content. The AR content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and/or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device) and/or detected via image data captured by an imaging device of a wearable device (e.g., a camera of a head-wearable device)) or a combination of the user’s hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight sensors, sensors of an IMU) detected by a wearable device worn by the user and/or other electronic devices in the user’s possession (e.g., smartphones, laptops, imaging devices, intermediary devices, and/or other devices described herein).

As described herein, a baseline sequence of typing input motions includes a sequence of hand motions performed by a user (e.g., in-air hand, near-surface, and/or surface-contact hand gestures) that directly corresponds to the motions (e.g., keystrokes) that the user would need to perform to produce the same text (e.g., target inputs) using typing inputs at a physical keyboard.

As described herein, devolved sequences of typing input motions are sequences of typing input motions that can be performed by the user to produce the same target inputs as would be produced by baseline sequences of typing input motions (e.g., directly pressing each key required to perform a user input), but which are in some way optimized (e.g., involving fewer typing input motions than the corresponding baseline sequences of typing input motions) for the user 302 to perform and/or for the computing system to detect.

As described herein, co-adaptation refers to a process of concurrently adapting (i) a model (e.g., a generative model, such as a large-language model (LLM)) and (ii) a user’s behavior based on the respective tendencies of the model and the user, respectively. In other words, a co-adapted model becomes personalized based on aspects of a user’s interactions with the model. In some embodiments, co-adaptation between a user and a generative model can be considered bi-directional (e.g., the model is capable of providing instructions to the user for adapting the user’s performance of certain typing input motions such that they are more likely to be correctly interpreted by the model).

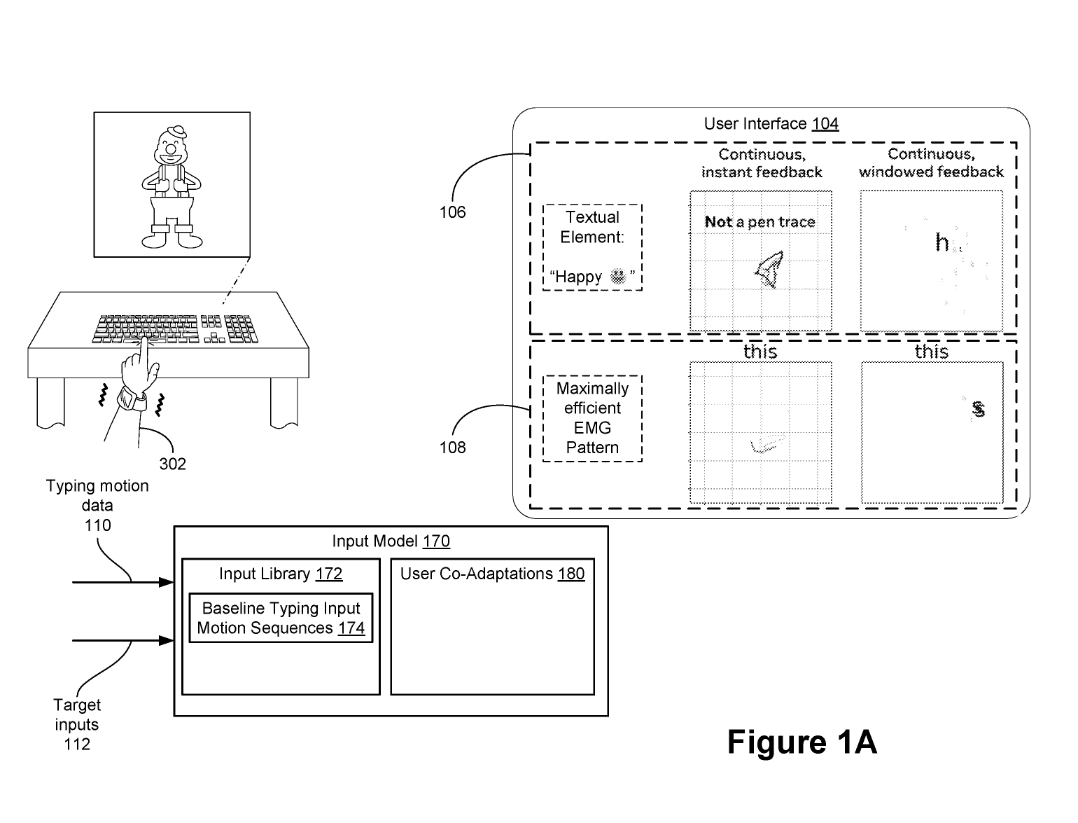

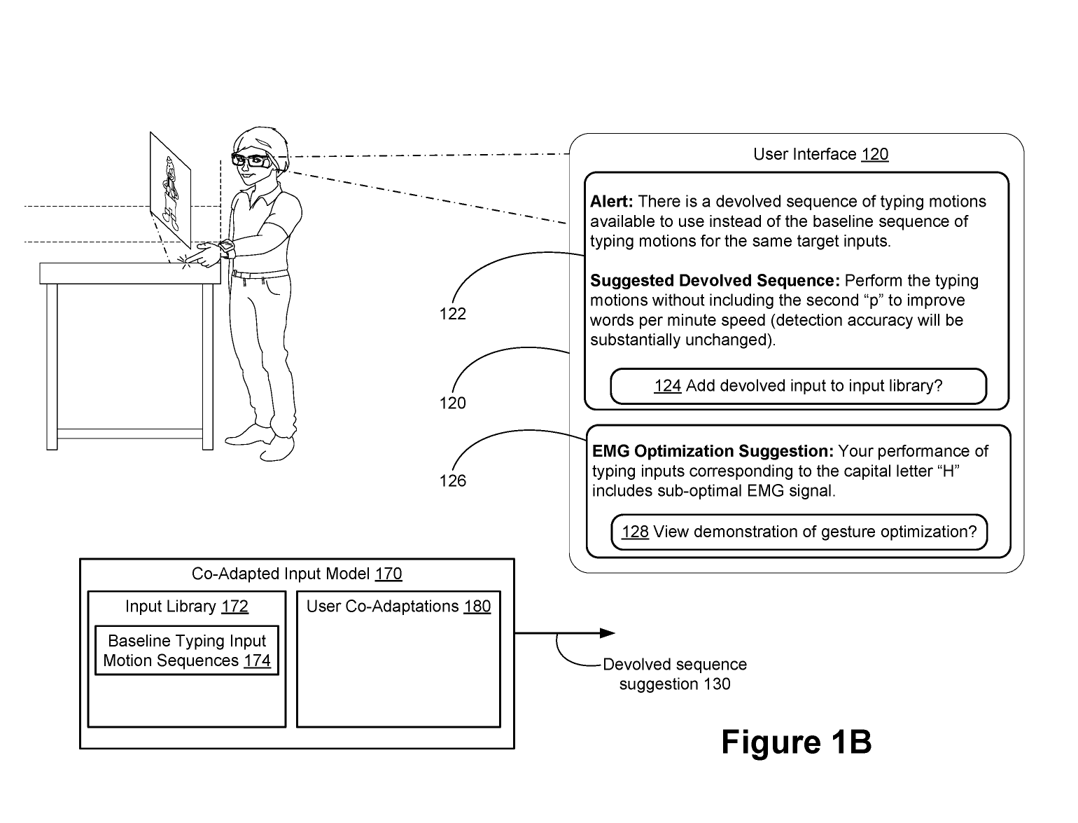

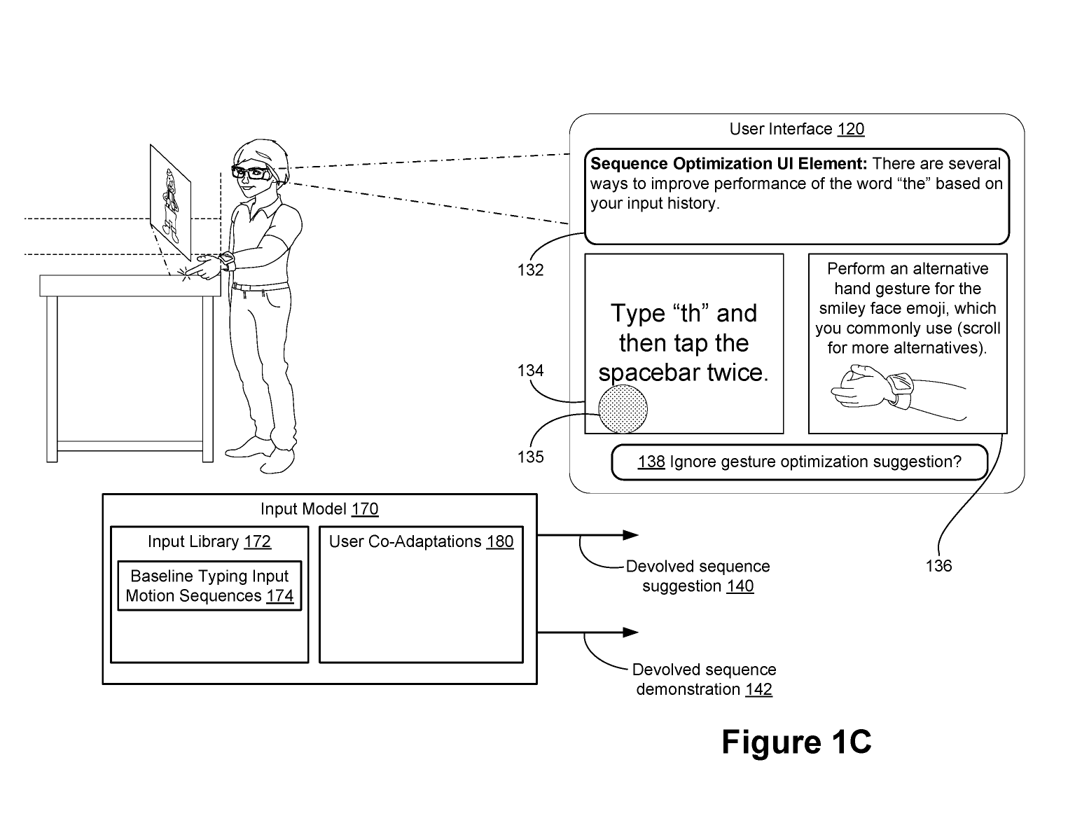

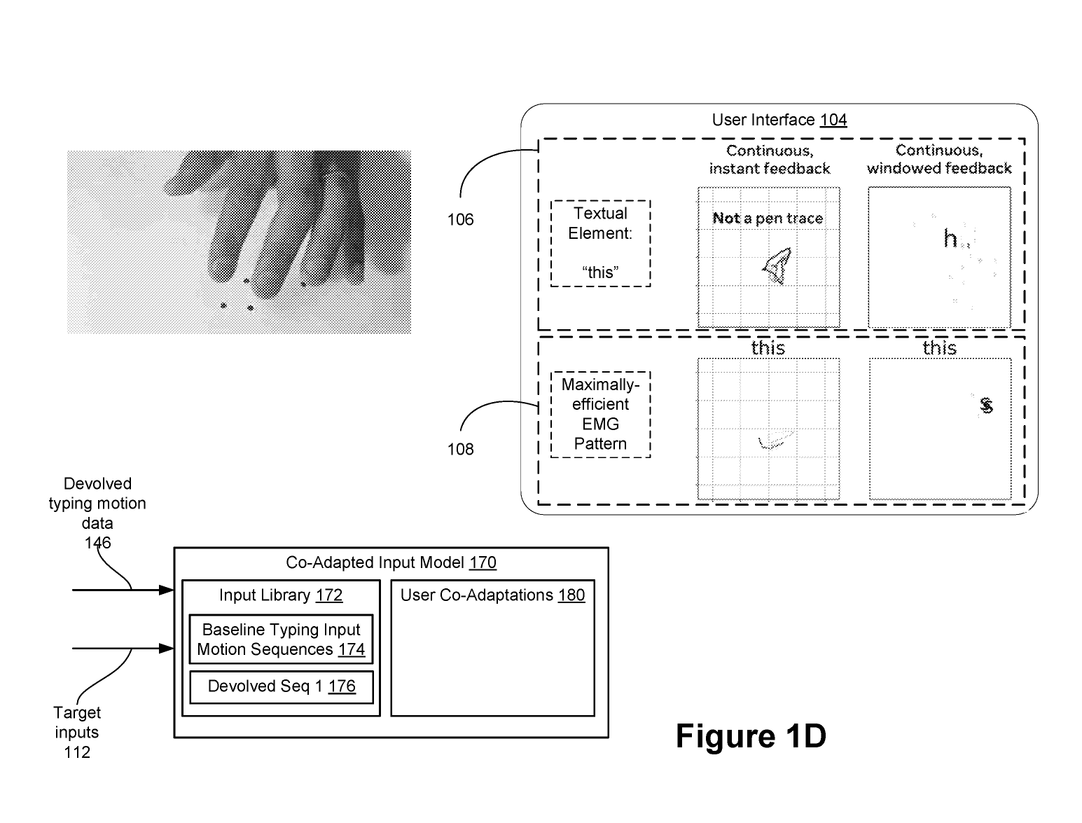

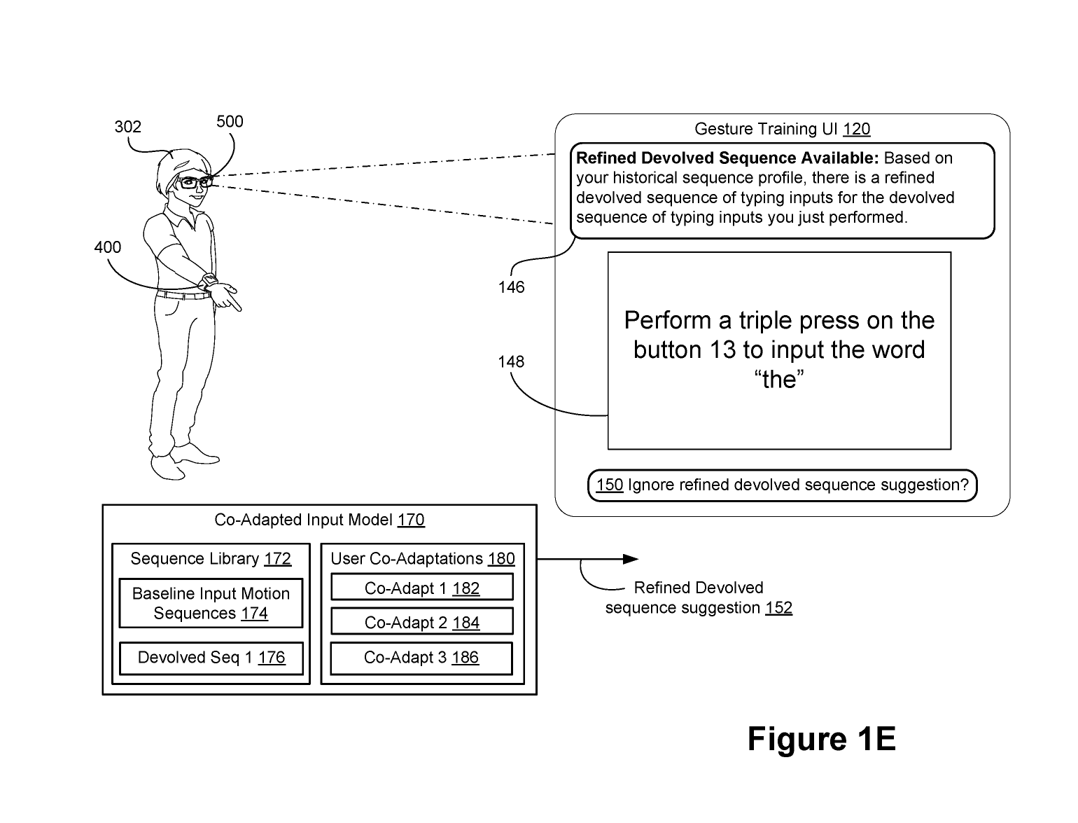

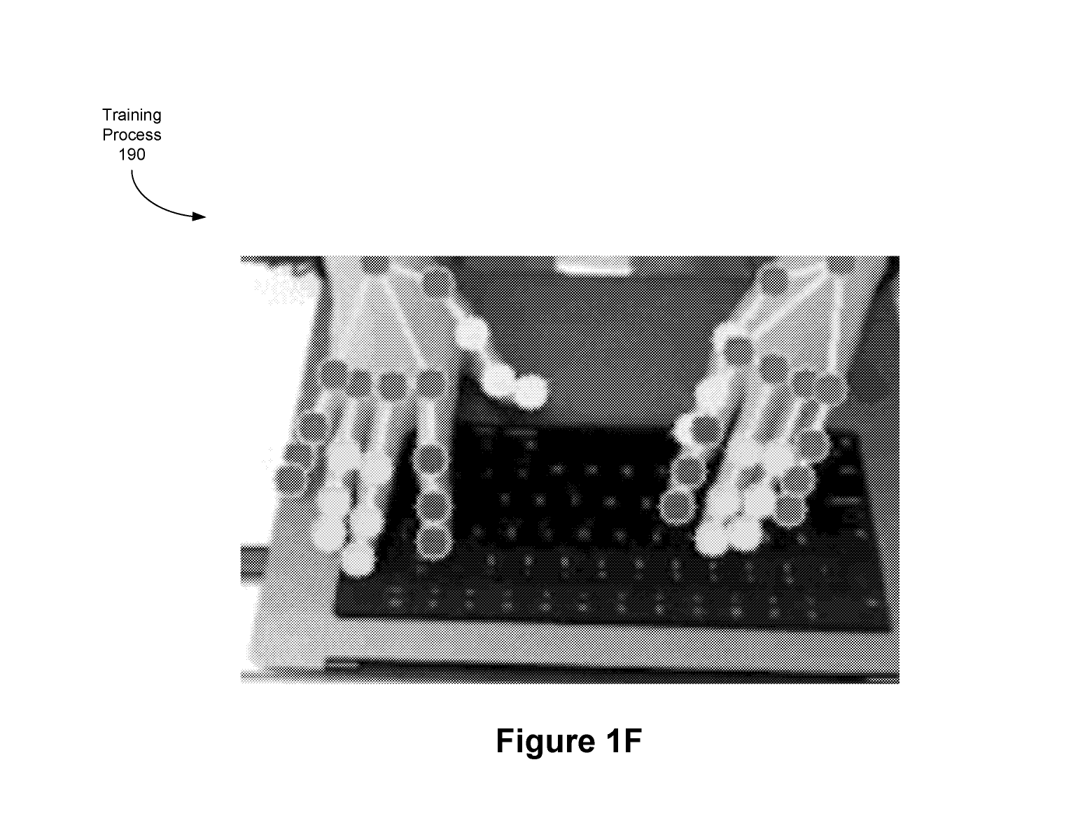

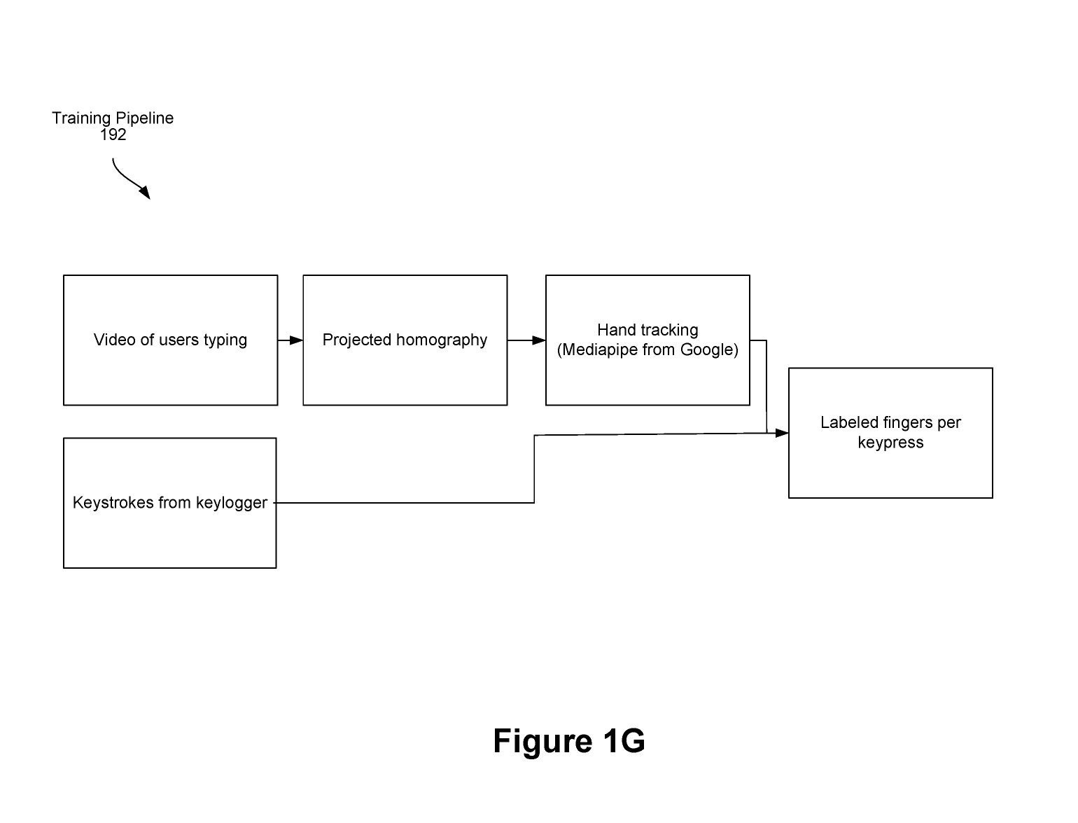

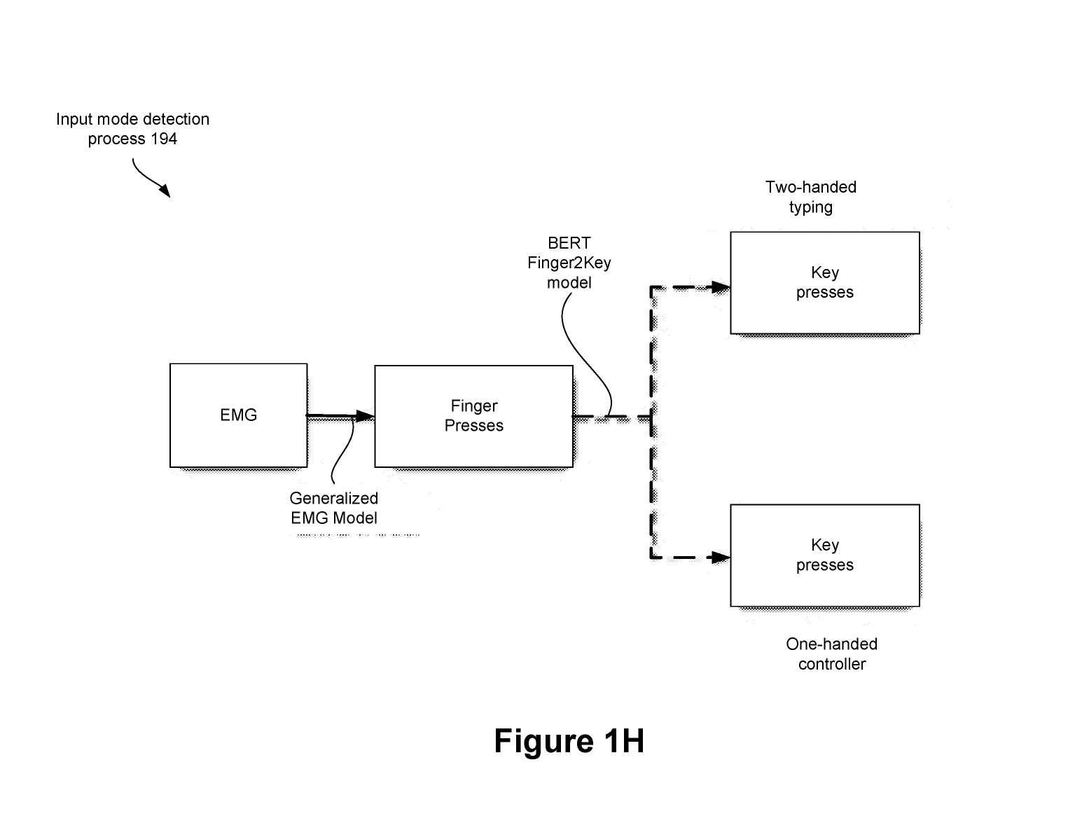

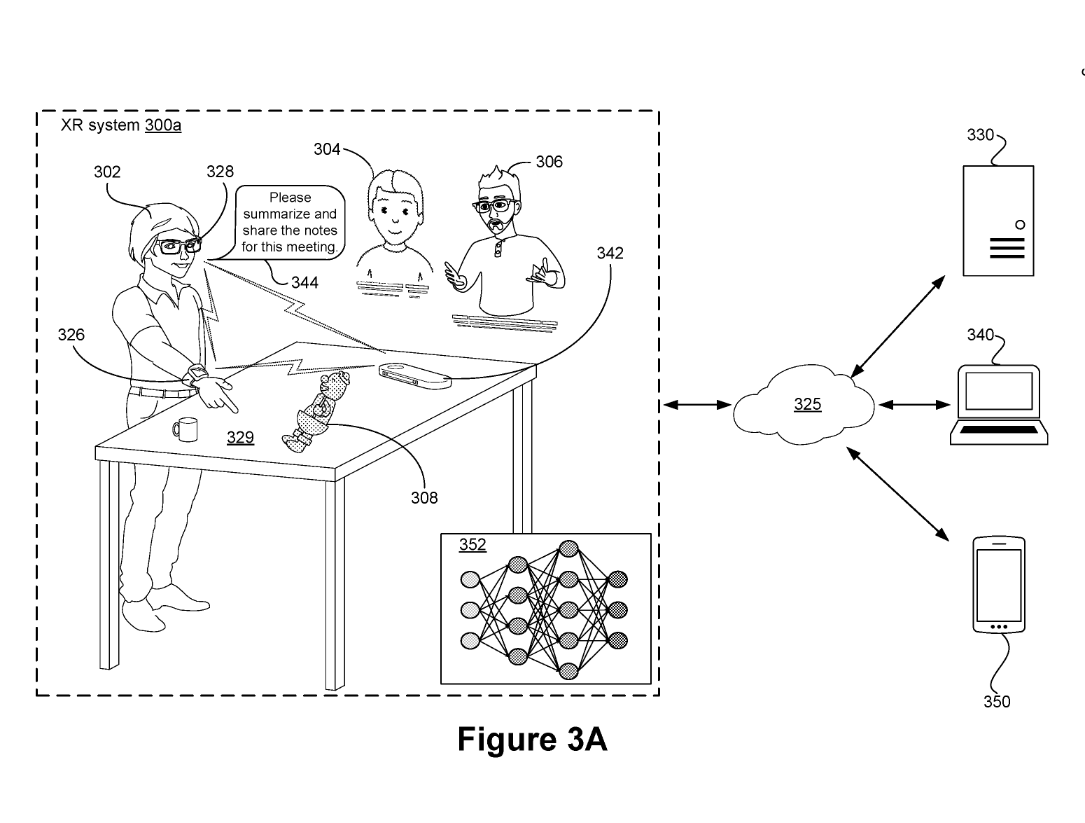

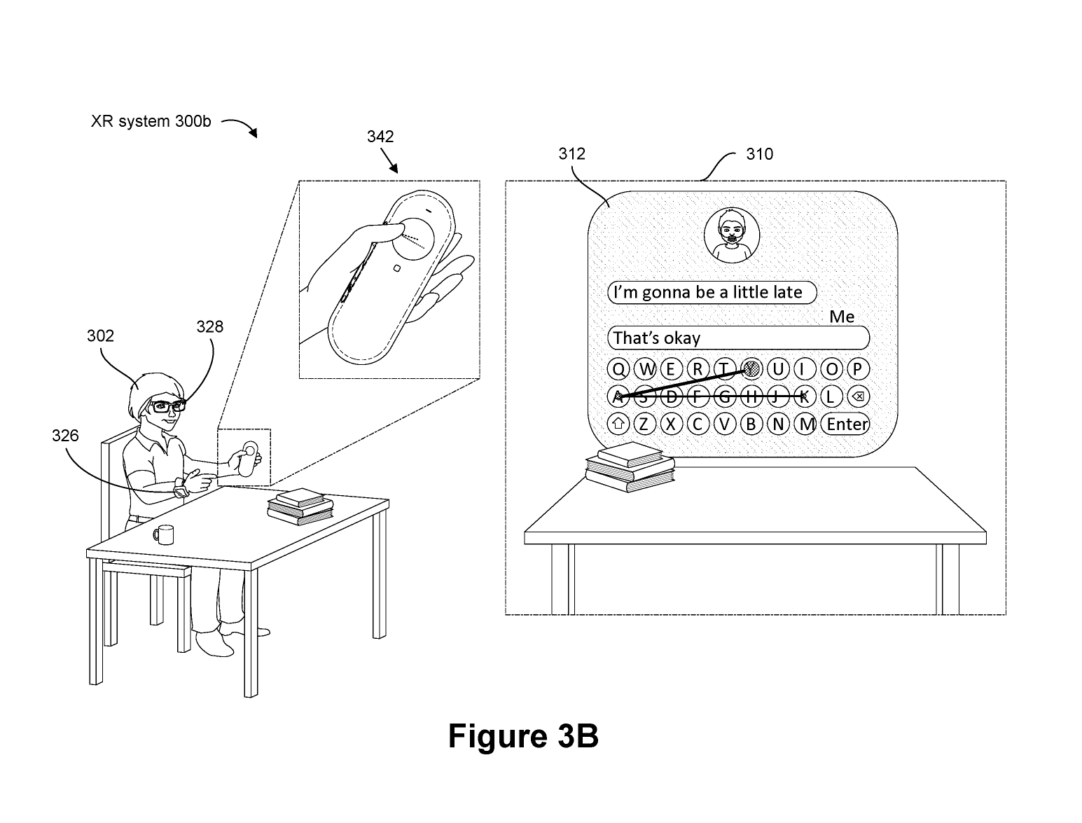

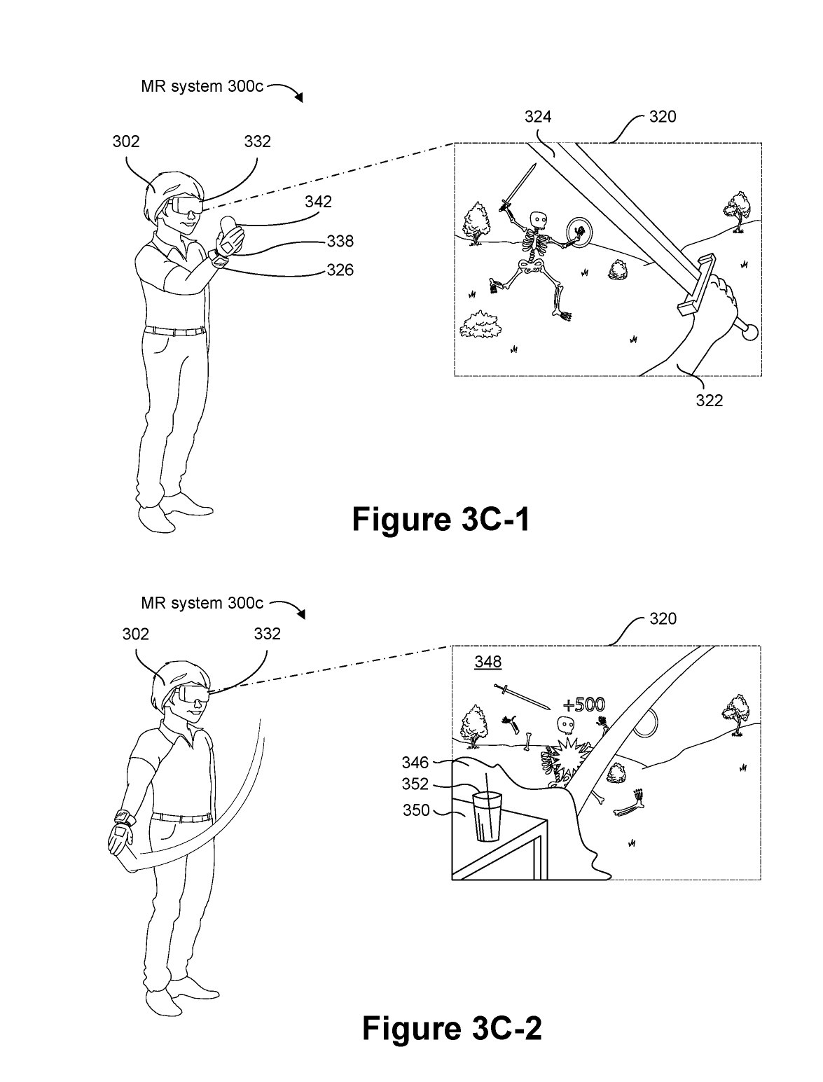

FIGS. 1A to 1G illustrate an example AR system 300a (which is described in more detail with respect to FIG. 3A) that is causing operations to be performed for determining target inputs based on a sequence of typing input motions performed by a user 302 and identifying devolved sequences of typing input motions (e.g., a devolved sequence suggestion 130 shown in FIG. 1B), in accordance with some embodiments.

FIG. 1A shows the user 302 performing the sequence of typing input motions 102 while wearing wrist-wearable device 326. The wrist-wearable device 326 is part of a computing system 300a that also includes a head-wearable device being worn by the user 302 (e.g., AR device 328, MR device 332). But a skilled artisan will appreciate that computing systems including various different combinations of one or more different components can be used for performing some or all of the operations described herein (e.g., AR system 300b, AR system 300c, and AR system 300d).

The sequence of typing input motions 102 corresponds to a set of target inputs for the phrase “Happy : ).” Specifically, the sequence of typing input motions 102 that the user 302 is performing in FIG. 1A is described herein as a baseline sequence of typing input motions, in that it includes respective typing motions that directly correspond to the same motions that the user 302 would need to perform to produce handwritten characters corresponding to the one or more target inputs (e.g., “pen-and-paper” sequences of letters and other characters). For example, a baseline sequence of typing motions corresponding to the letter “H” would include two vertical lines, and a horizontal line that spatially connects the two vertical lines.

In accordance with some embodiments, the input model 170 includes a sequence library 172 that includes data (e.g., algorithms, detection models) for identifying one or more target inputs that the user 302 is attempting to produce by performing the sequence of typing input motions 102. In some embodiments, the sequence library 172 is preconfigured with data for detecting sets of characters (e.g., alphanumeric text, numbers, and a select set of emojis) based on baseline sequences of typing input motions. In accordance with some embodiments, the input model 170 is calibrated, or otherwise co-adapted for the user 302 based on, for example, historical data including data obtained while the user 302 was performing sequences of typing input motions.

In some embodiments, the input model 170 receives data (e.g., the typing input sequence data 110 and target input data 112 indicating the one or more target inputs that the user 302 is attempting to perform via the sequence of typing input motions 102) from one or more data input devices of the computing system (e.g., biopotential-signal-sensing components, such as EMG sensors of the wrist-wearable device 326 and/or imaging sensor, such as cameras, that are located on the wrist-wearable device 326 or the AR device 328). In some embodiments, the input model utilizes sensor fusion to combine data from a variety of sources. In some embodiments, the input model 170 includes, and/or is coupled with a generative model configured to perform various operations related to devolved sequences of typing input motions. For example, a generative model may be used to identify a devolved sequence of typed input motions to suggest to the user 302 based on a sequence of typing input motions detected by the input model 170. In some embodiments, the same or a different generative model (e.g., an LLM) may be used to generate a representation of the identified devolved sequence of typed input motions (e.g., an instructional demonstration, and/or textual output instructing the user 302 how to perform the devolved sequence of typed input motions). In some embodiments, the input model 170 is co-adapted to the user 302. That is, the input model 170 may be uniquely personalized to the user 302 based on preferences and/or tendencies of the user related to their performance of gestures (e.g., sequences of typing input motions) to produce target inputs.

While the user 302 performs the sequence of typing input motions 102, a user interface 104 (e.g., a gesture calibration user interface) is presented by an electronic device of the computing system 300a (e.g., a display of the wrist-wearable device 326, a display of the AR device 328). The user interface 104 presents information (e.g., real-time data obtained by the wrist-wearable device 326) while the user 302 attempts to perform sequences of typing input motions. For example, the user interface includes a user interface element 106, which includes a representation of data being obtained by one or more biopotential-signal-sensing components of the wrist-wearable device 326, in accordance with some embodiments.

In conjunction with presenting the real-time data with the user interface element 106, the user interface 104 includes another user interface element 108, which includes a representation of data that would be produced within the user interface element 106 if the user 302 had performed a maximally efficient sequence of typing input motions for the same one or more target inputs. In some embodiments, the maximally-efficient sequence of typing input motions shown by the user interface element 108 includes the same baseline sequence of typing input motions that the user 302 attempted to perform via the sequence of typing input motions 102. In some embodiments, the maximally-efficient sequence of typing input motions includes a devolved sequence of typed input motions that has already been stored within the sequence library 172 (e.g., providing a reminder to the user that the devolved sequence of typed input motions is available for causing and/or obtaining the one or more target inputs). In accordance with some embodiments, the input model 170 is further configured to include a user co-adaptations module 180, which includes a set of co-adaptations that are specific to the user 302. For example, a particular co-adaptation may indicate that the user 302 is more likely to learn devolved sequences of typing input motions that include particular types of typing input motions (e.g., particular keystrokes and/or combinations thereof based on training data including a plurality of typed inputs).

FIG. 1B shows the AR system 300a after the user 302 has finished performing the sequence of typing input motions 102 shown in FIG. 1A. Another user interface 120 is being presented to the user 302, the user interface 120 including an alert that a devolved sequence of typed input motions is available to be performed for the same one or more target inputs that the sequence of typing input motions 102 corresponds to (e.g., a devolved sequence suggestion 130). The alert user interface element 122 includes an indication stating: “Alert: There is a devolved sequence of typed input motions available to use instead of the baseline sequence of typing input motions for the same target inputs.” The alert user interface element 122 also includes information about how to perform the suggested devolved sequence of typed input motions (e.g., “Suggested Devolved Sequence: Perform the typing motion without including the second ‘p’ to improve words per minute speed (detection accuracy will be substantially unchanged).”). That is, in accordance with some embodiments, a devolved sequence of typed input motions corresponding to one or more target inputs (e.g., the word “Happy”) may include substantially the same set of typing input motions for each of the individual letters, except that the devolved sequence of typed input motions may omit a particular portion of the sequence of typing input motions 102 (e.g., “dropping” a double letter).

The user interface 120 also includes a user interface element 126, which includes a suggestion for how the user 302 can improve performance of the sequence of typing input motions 102 that the user 302 performed in FIG. 1A (stating: “EMG Optimization Suggestion: Your performance of typing inputs corresponding to the capital letter ‘H’ includes sub-optimal EMG signal.”), in accordance with some embodiments. The user interface element 126 includes a selectable user interface element 128 that the user can select (e.g., using a directed tap input) to cause a demonstration of the sequence optimization. In some embodiments, the AR system 300a includes a neural network (e.g., an LLM) that is configured to generate representations of particular suggestions provided by the input model 170. For example, after the input model 170 identifies a devolved sequence suggestion 130 to suggest to the user 302, an LLM may receive information about the devolved sequence suggestion 130 and generate a visual demonstration (e.g., written instructions, a visual animation) of the devolved sequence suggestion 130 to present to the user 302.

FIG. 1C shows the AR system 300a after the user 302 has input a selection not to add the devolved sequence suggestion 130 to the sequence library 172 of the input model 170. Based on the user input not to add the devolved sequence suggestion 130 to the sequence library 172, the user interface 120 is presenting new user interface elements corresponding to additional devolved sequence suggestions for the user 302 based on the sequence of typing input motions 102 (an informational user interface element 132 stating: “Sequence Optimization UI Element: There are several ways to improve performance of the word ‘the’ based on your input history.”). The user interface 120 includes demonstration user interface elements 134 and 136 including respective representations (e.g., demonstrations) for the other devolved sequence suggestions. In accordance with some embodiments, based on the user 302 forgoing adding the devolved sequence of typed input motions suggested to the user as part of the devolved sequence suggestion 130, a particular co-adaptation 182 is added to the user co-adaptations module 180 of the input model 170, which may be used to determine future devolved sequence suggestions to present to the user 302.

The demonstration user interface element 134 includes a visual depiction of a typing input motion corresponding to one of the letters of the target inputs that the user intended to produce by performing the sequence of typing input motions 102 shown in FIG. 1A (stating: “Type ‘th’ and then tap the spacebar twice,” and including a visual depiction of the devolved sequence suggestion 140 that includes a three-dimensional plane). That is, in accordance with some embodiments, a devolved sequence of typed input motions can include a portion of a sequence of typing input motions that is performed in an additional dimensional plane that was not implicated by the original sequence of typing input motions. The other demonstration user interface element 136 includes a visual depiction of a devolved sequence of typed input motions that includes an EMG-detectable substitute gesture (e.g., a pinch gesture) that the user 302 can perform instead of the portion of the sequence of typing input motions corresponding to a particular target input (or set of target inputs). In some embodiments, EMG-detectable substitute gestures may be suggested for particular target inputs that the user 302 commonly performs.

In accordance with some embodiments, the input model 170 may include one or more user co-adaptations module 180 based on actions performed by the user. That is, the input model 170 may be or include a co-adaptive component that is configured to cause the input model 170 to co-adapt to the user 302 (e.g., based on user-specific aspects of typing input motion data, user preferences related to learning new sequences of typing input motions, and/or user-specific learning styles or learning rates for learning devolved sequences of typing input motions). For example, the user co-adaptations module 180 may include a particular co-adaptation 182 based on the user forgoing to add the devolved sequence suggestion 130 to the sequence library 172. The user 302 is performing a gesture corresponding to a user selection 135 of the demonstration user interface element 134.

In some embodiments, multiple devolved sequences of typing input motions may be suggested to the user 302 as part of a multipart devolved sequence suggestion, where each of the respective devolved sequence suggestions of the multipart devolved sequence suggestion correspond to different respective target inputs of the one or more target inputs. In some embodiments, one or more devolvement criteria are used to determine which of a plurality of candidate devolved sequences of typing input motions to suggest to the user 302. For example, a particular devolvement criterion may be based on a reduction in the amount of exertion that the user is required to exert in performing the devolved sequence of typed input motions.

FIG. 1D shows the AR system 300a while the user 302 is performing the devolved sequence of typed input motions corresponding to the devolved sequence information 176 selected by user selection 135 in FIG. 1C for the same set of target inputs (e.g., the phrase “Happy : )”). While the user 302 is performing the devolved sequence of typed input motions 144, the user interface 104 presents similar content for the devolved sequence of typed input motions 144 as it did for the sequence of typing input motions 102 shown in FIG. 1A. Based on the user selection in 1C selecting the devolved sequence of typed input motions, devolved sequence information 176 is added to the sequence library 172 for the user 302, and another particular co-adaptation 184 is added to the user co-adaptations module 180 based on the user 302 choosing to learn the devolved sequence of typing input motions presented by the demonstration user interface element 134.

FIG. 1E shows AR system 300a after the user has performed the devolved sequence of typed input motions 144 based on the devolved sequence suggestion selected in FIG. 1C. Based on the performance of the devolved sequence of typed input motions 144 by the user 302 in FIG. 1D, the user interface 120 is presenting information to the user about a refined devolved sequence of typed input motions based on the performance of the devolved sequence of typed input motions 144 (an informational user interface element 146, stating: “Refined Devolved Sequence Available: Based on your historical sequence profile, there is a refined devolved sequence of typing inputs for the devolved sequence of typing inputs you just performed.”). A demonstration user interface element 148 presents a visual demonstration of a refined devolved sequence suggestion 150 that is suggested to the user 302 based on the performance of the devolved sequence of typed input motions 144. Based on a user selection 151 of the refined devolved sequence suggestion 150 that is presented by the user interface element 148, another particular co-adaptation is added to the user co-adaptations module 180 of the co-adapted input model 170 that is associated with the user 302.

FIG. 1F shows the AR system 300a while the user 302 performs various iterations of a sequence of typing input motion and is receiving feedback (e.g., instantaneous or near-instantaneous feedback) about the performance of a sequence of typing input motions 160 that the user 302 is performing over a span of time (e.g., as part of a training process 190). In some embodiments, the training process 190 includes obtaining video data of the user 302 performing typing input motions while simultaneously capturing keystroke data from a keylogger or other input capture mechanism, such that the system can correlate the user’s hand movements with the corresponding target inputs being produced. In some embodiments, the training process 190 may include presenting the user 302 with prompts to type particular words or phrases, and the system may compare the user's performance against reference data to identify areas for improvement. In some embodiments, the training process 190 may be used to calibrate the input model 170 for the user 302, such that the input model 170 can more accurately detect sequences of typing input motions performed by the user 302. In some embodiments, the training process 190 may include multiple sessions over a period of time, allowing the input model 170 to adapt to changes in the user’s typing patterns or physical characteristics.

FIG. 1G shows an example training pipeline 192 for a system of detecting one or more target inputs corresponding to typing input motions performed by a user, which may be used to train the input model 170. In some embodiments, the training pipeline includes obtaining video of users typing (e.g., via the training process 190 shown in FIG. 1F). In some embodiments, based on obtaining the video of the users typing the system is configured to determine a projected homography, which can be used to map typing input commands to a keyboard template, in accordance with some embodiments. In some embodiments, the system can provide the projected homography to hand tracking data to determine labels for the fingers corresponding to each key press.

FIG. 1H shows an example of an input mode detection process 194 for determining a mode of input (e.g., controller button presses, keyboard keystrokes) that a user is performing based on neuromuscular signal data (e.g., EMG data) obtained at one of more wearable devices being worn by a user 302 while they are performing inputs corresponding to typing motions. In some embodiments, the input mode detection process 194 includes, in accordance with obtaining the neuromuscular signal data, the input model 170, which may be configured to determine a set of finger presses corresponding to the neuromuscular signal data. Based on determining the set of finger presses, and in accordance with determining a projected homography of the user (as described with respect to FIG. 1G), the input model 170 may be used to determine a respective target controller to which the target inputs correspond. In some embodiments, one or more surrounding target inputs that were provided by the user before or after the user provides the input being determined (for example, if the user performs a first typing motion corresponding to a “t” and a third typing motion corresponding to an “e,” the input model 170 may determine that the user is most likely intending the second input to correspond to typing the letter “h” (which may be based on additional surrounding context)).

### Example Embodiments

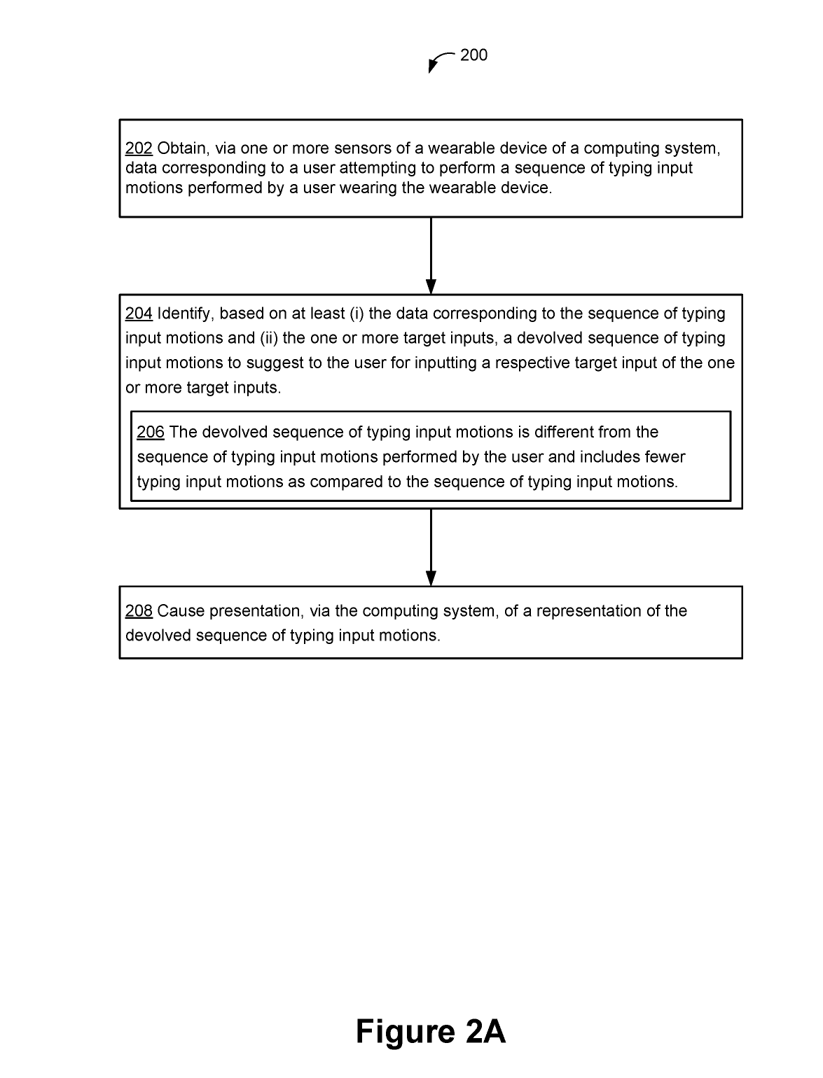

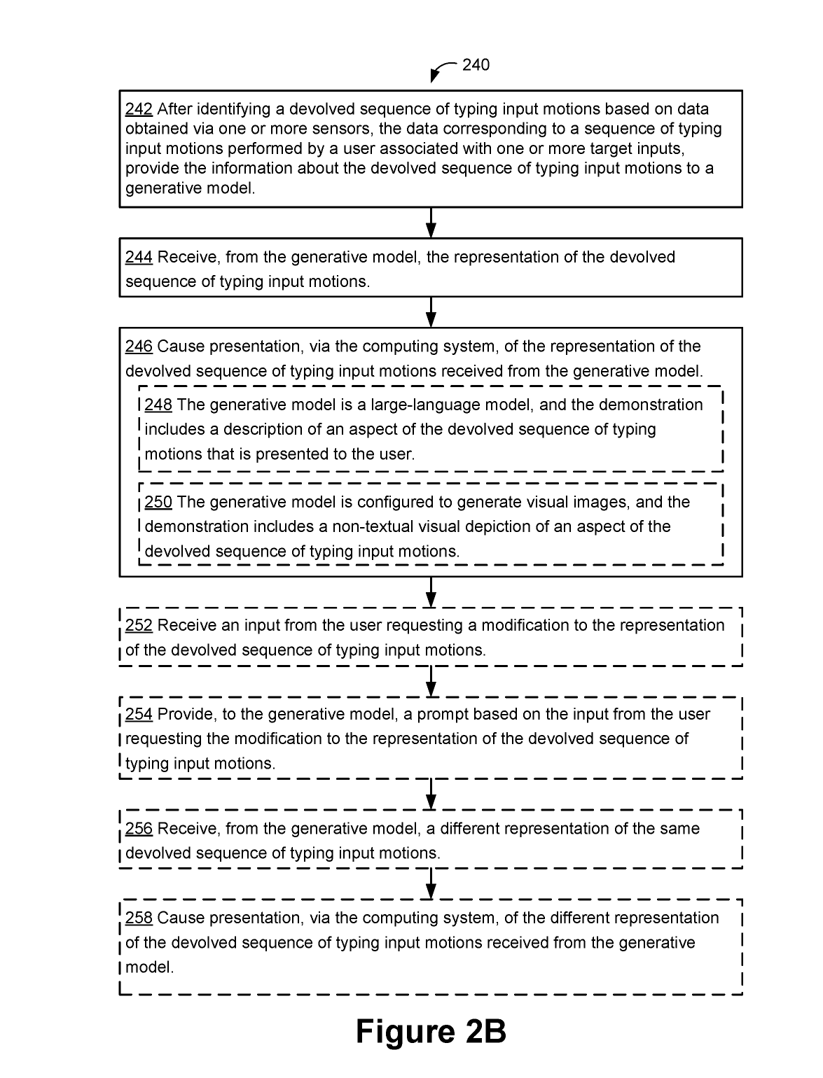

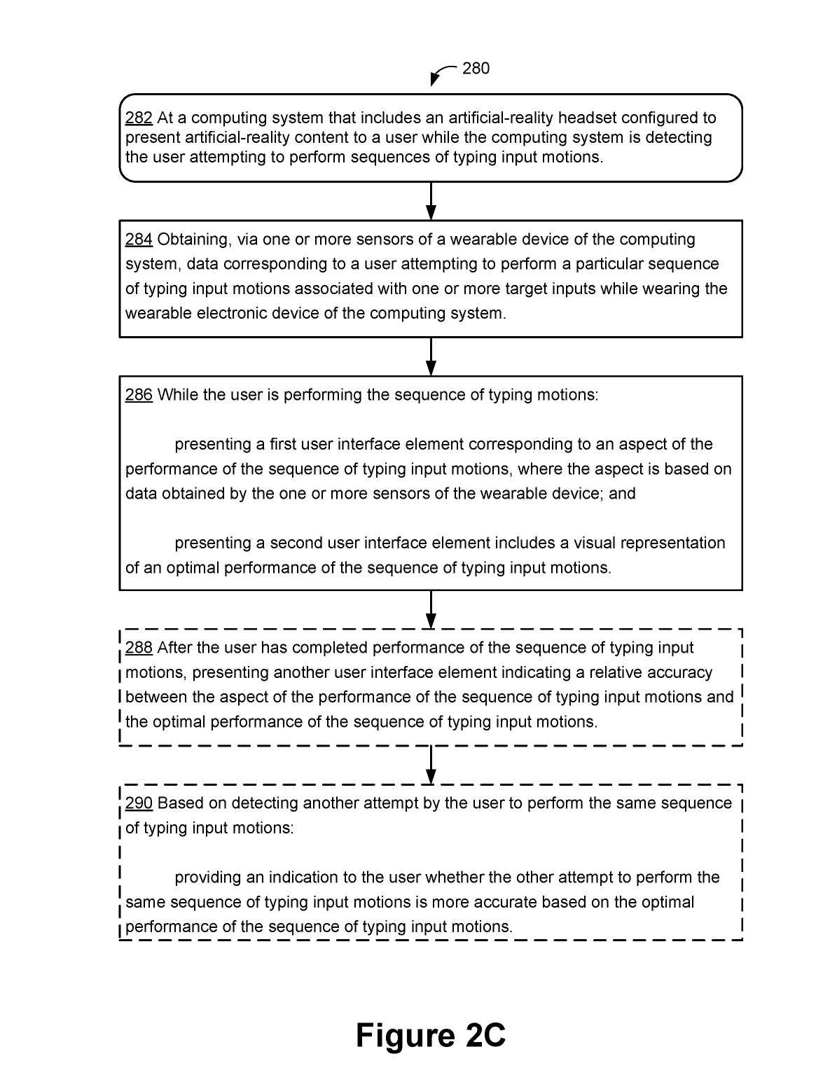

FIGS. 2A to 2C illustrate various embodiments of techniques related to devolving sequences of typing input motions performed by users of computing systems that include components described herein. In particular: (i) FIG. 2A illustrates an example method 200 of identifying devolved sequences of typing input motions based on users’ attempts to perform sequences of typing input motions corresponding to target inputs; (ii) FIG. 2B illustrates another example method 240 of presenting representations of identified sequences of typing input motions to a user by applying the sequences of typing input motions to a generative model that is co-adapted to a user of the computing system; and (iii) FIG. 2C illustrates yet another example method 280 of presenting user interfaces to users that include representations of aspects of the users’ performances of sequences of typing input motions.

For explanatory purposes, the various blocks of the processes 200, 240, and 280 are described herein with reference to FIGS. 1A to 1F, and the associated components and/or processes described herein with respect to FIGS. 3A to 3C-2. For example, operations (e.g., steps) of the methods 200, 240, and/or 280 can be performed by one or more processors (e.g., central processing unit and/or a microcontroller unit) of the system 300a. Some of the operations of the example methods shown in FIGS. 2A to 2C correspond to instructions stored in a computer memory or computer-readable storage medium.

Operations of the example methods shown in FIGS. 2A to 2C can be performed by a single device alone, or in conjunction with one or more processors and/or hardware components of another communicatively-coupled device (e.g., the wrist-wearable device 326 in conjunction with the AR device 328) and/or instructions stored in memory or computer-readable media of the other device communicatively coupled to the system. In some embodiments, the various operations of any of the methods shown in FIGS. 2A to 2C are interchangeable and/or optional, and respective operations of the methods can be performed by any of the devices and/or constituent components of the components described herein. For convenience, the method operations will be described below as being performed by particular components or devices, but should not be construed as limiting the performance of the operation to the particular device in all embodiments.

The one or more blocks of methods 200, 240, and 280 may be implemented, for example, by one or more computing devices of the AR system 300a including, for example, the wrist-wearable device 326 and/or the AR device 328. In some embodiments, two or more electronic devices within a respective computing system can operate in tandem (e.g., as part of a device constellation) to perform the operations described herein. For example, respective sensors of the wrist-wearable device 326 and/or the AR device 328 may collect data related to a user’s performance of a sequence of typing input motions (e.g., a baseline sequence of typing input motions, a devolved sequence of typed input motions), and the respective sensor data can be provided to an intermediary processing device (e.g., the handheld intermediary processing device (HIPD) 342, a remote server (e.g., a respective server of the one or more servers 330)).

### Concept 1. Devolving typing input through co-adaptation of a typing-motion-detection model.

(A1) FIG. 2A shows a flow chart of the example method 200 of identifying devolved sequences of typing input motions to suggest to a user based on detected attempts to perform sequences of typing input motions (e.g., baseline typing input motions (e.g., keystrokes) for one or more characters of alphanumeric text).

As part of the AR system 300a performing the method 200, the wrist-wearable device 326 obtains (202), via one or more sensors of the wrist-wearable device 326 (e.g., EMG sensors of the wrist-wearable device 326), data corresponding to a user attempting to perform a sequence of typing input motions associated with one or more target inputs (e.g., alphanumeric text, and/or special characters, such as emojis) while wearing the wrist-wearable device 326. For example, in FIG. 1A, data may be obtained by one or more EMG sensors of the wrist-wearable device 326. In some embodiments, the data corresponding to the user 302 attempting to perform the sequence of typing input motions is obtained, at least in part, by one or more imaging sensors (e.g., external-facing cameras, such as a left camera and/or a right camera) of the AR device 328. In some embodiments, first data collected by one or more sensors of a first device (e.g., the wrist-wearable device 326), and second data collected by one or more sensors of a second device (e.g., the AR system 300a) are provided to the same input model 170 (e.g., as part of a sensor fusion operation) in order to increase the confidence of detection of the sequence of typing input motions.

Performance of the method 200 includes identifying (204), based on at least (i) the data corresponding to the sequence of typing input motions, and (ii) the one or more target inputs, a devolved sequence of typed input motions to suggest to the user for inputting a respective target input of the one or more target inputs (e.g., the devolved sequence suggestion 130 shown in FIG. 1B). The devolved sequence of typed input motions is different from the sequence of typing input motions performed by the user and includes fewer typing input motions (e.g., less muscular activations by the user’s hand or forearm) as compared to the sequence of typing input motions (206). In some embodiments, one or more portions of the devolved sequence of typed input motions are the same as the sequence of typing input motions that the user 302 originally performed. For example, the devolved sequence suggestion 130 shown in FIG. 1B includes all of the same typing input motions for the individual letters and characters but involves dropping the second “p” in the word “happy.” In contrast, some devolved sequences of typing input motions may include typing input motions that do not correspond to any baseline sequences of typing input motions (e.g., a “thumbs-up” hand gesture may be a devolved sequence of typed input motions for the word “yes”).

Finally, the AR system 300a causes (208) presentation (e.g., using the display of the AR system 300a), of a representation of the devolved sequence of typed input motions. For example, as described in more detail with respect to the method 240 discussed with respect to FIG. 2B, data (related to the devolved sequence of typed input motions may be provided to a generative model (e.g., an LLM), and the generative model may generate an output that includes a demonstration that includes one or more textual, visual, audial, and/or haptic components related to representing the devolved sequence of typed input motions.

(A2) In some embodiments of A1, one or more sensors of the wearable device (e.g., the wrist-wearable device 326) obtain other data corresponding to the user 302 attempting to perform the devolved sequence of typed input motions associated with the respective target input of the one or more target inputs. For example, in FIG. 1D, sensors of the wrist-wearable device 326 are used to detect that the user 302 is performing the devolved sequence of typed input motions 144. The AR system 300a identifies, based on at least (i) the other data corresponding to the user attempting to perform the devolved sequence of typed input motions and (ii) the respective target input of the one or more target inputs, a refined devolved sequence of typed input motions to suggest to the user 302 for inputting the respective target input (e.g., the refined devolved sequence suggestion 152). The refined devolved sequence of typed input motions is a different sequence as compared to the devolved sequence of typed input motions identified based on the sequence of typing input motions, and includes fewer typing input motions than the sequence of typing input motions (e.g., the sequence of typing input motions 102 in FIG. 1A). And the AR system 300a causes presentation, via the computing system, of a representation of the refined devolved sequence of typed input motions.

That is, the systems, devices, and methods described herein provide for dynamic fine-tuning of devolved sequences of typing input motions and baseline sequences of typing input motions that are continuously co-adapted based on the user’s usage and/or efficiency in performing particular sequences of typing input motions, and/or based on the user’s historical rate of learning new devolved sequences of typing input motions. For example, a particular set of devolved sequences of typing input motions may be based on an objective of reducing sequences of typing input motions to singular strokes at particular angles relative to the user, and each refinement and/or devolvement of the sequence of typing input motions may be based on achieving the objective of providing a library of single-stroke gestures to the user (e.g., to be stored in the sequence library 172).

(A3) In some embodiments of A2, the devolved sequence of typed input motions is selected from a predefined set of devolved sequences corresponding to particular target inputs, and the refined devolved sequence is identified via a self-supervised model that is co-adapted based on sequences of typing input motions performed by the user (e.g., stored as user co-adaptation within the user co-adaptations module 180 shown in FIGS. 1A to 1F). In other words, the AR system 300a can identify suggestions of devolved sequences based on a combination of (i) a pre-configured library and/or supervised learning techniques for suggesting devolved sequences (e.g., based on pre-defined devolvement objectives) and (ii) an unsupervised learning technique that suggests devolved sequences based on, for example, real-time criteria about the user 302’s performance of respective sequences of typing input motions and/or other devolved sequences of typing input motions.

(A4) In some embodiments of any one of A1 to A3, the AR system 300a identifies another devolved sequence of typed input motions to suggest to the user 302 for inputting a different respective target input of the one or more target inputs (e.g., in conjunction with identifying the devolved sequence of typed input motions). In some embodiments, the devolved sequence of typed input motions and the other devolved sequence of typed input motions, both individually and collectively, include fewer typing input motions as compared to the sequence of typing input motions. For example, in identifying a devolved sequence of typed input motions to suggest to the user 302 based on the user 302 performing a baseline sequence of typing input motions for each of the individual letters in the word “happy,” the AR system 300a may provide a first devolved sequence of typed input motions that includes a different sequence of typing input motions for the letter “h,” and a devolved sequence for performing the double-p character sequence (e.g., suggesting a dropped letter).

(A5) In some embodiments of A4, the devolved sequence of typed input motions and the other devolved sequence of typed input motions, together, form a multipart set of devolved sequences corresponding to the one or more target inputs, and the multipart set of devolved sequences is selected based on comparing the multipart set of devolved sequences of typing input motions to the devolved sequence of typed input motions based on one or more devolvement criteria related to the respective sequences. That is, the systems, devices, and methods described herein can be used to determine that a combination of different devolved sequences would be most effective, intuitive, and/or efficient for suggesting to the user, instead of a single devolved sequence of typed input motions for performing all of the one or more target inputs.

(A6) In some embodiments, the one or more devolvement criteria include respective criteria related to minimizing a legibility constraint for identifying the one or more target inputs based on the devolved sequence of typed input motions (e.g., distinguishing or otherwise disambiguating the one or more intended target inputs based on the sequence of typing input motions). In some embodiments, the legibility constraint is based on a discriminability of the sequence of typing input motions (e.g., an estimated accuracy of distinguishing the one or more target inputs from other target inputs that includes similar typing input motions). In some embodiments, the one or more devolvement criteria include respective criteria related to reducing an amount of exertion required for performing the devolved sequence of typed input motions (e.g., motor activity, an amount of arm movements, and/or a cumulative difficulty of performing the set of typing input motions). In some embodiments, the one or more devolvement criteria include respective criteria related to increasing an estimated speed of producing the one or more target inputs (e.g., words per minute).

In some embodiments, determining which of a plurality of devolved sequences to provide to the user (and/or whether to provide any devolved sequences of typing input motions to the user) includes comparing a respective value of one particular criterion against a different value of the same or a different particular criterion (e.g., an amount of reduction of exertion for performing the devolved sequence of typed input motions). For example, the devolved sequence suggestion 130 may have been presented to the user 302 in FIG. 1B instead of the other devolved sequence suggestions 140 and 142 shown in FIG. 1C based on comparing the respective devolved sequences of typing input motions corresponding to the devolved sequence suggestions 130, 140, and 142 based on relative satisfaction of respective devolvement criteria.

(A7) In some embodiments of A6, determining whether respective criteria related to the legibility constraint are satisfied includes (i) comparing a historical accuracy of an input-detection model for detecting the sequence of typing input motions to a predicted accuracy of the input-detection model for detecting respective devolved sequences of typing input motions and (ii) determining whether the respective devolved sequences of typing input motions result in increasing detection accuracy for the one or more target inputs by more than a threshold error reduction rate (e.g., a 5% reduction in the rate of false positives detected by the input-detection model).

In some embodiments, the input-detection model is configured to receive feedback indicating that a respective set of one or more typing input motions performed by the user was incorrectly identified as corresponding to a different textual element (e.g., a textual element that includes commonly confusing characters (e.g., h vs. n, b vs. p)). In some implementations, the feedback is provided by the user (e.g., providing an indication that the generated input is different than the target input intended by the user). In some implementations, the devolved sequence of typed input motions is identified based on a determination that a portion of the sequence that corresponds to a respective target input of the one or more target inputs has been mistakenly identified by the input-detection model at or above a threshold error rate.

(A8) In some embodiments of A6 or A7, determining whether respective criteria related to the speed of producing the one or more target inputs are satisfied includes identifying one or more portions of the sequence of typing input motions that the user performed with ballistic movement. As described herein, “ballistic movement” is defined as one or more muscular activations that exhibit maximum velocities and accelerations over a short period (e.g., exhibiting high firing rates, high force production, and very brief contraction times).

(A9) In some embodiments of any one of A1 to A8, in accordance with determining that removing one or more typing input motions of the sequence of typing input motions would reduce an accuracy of detecting target inputs by less than a threshold error rate (e.g., a predicted accuracy of the input-detection model would be reduced by less than five percent, eight percent, ten percent), the AR system 300a identifies the devolved sequence of typed input motions via determining the devolved sequence of typed input motions by removing the one or more typing input motions from the sequence of typing input motions that was performed by the user 302. For example, the system may determine that an input-detection model (e.g., a machine-learning model) for detecting which target inputs a user 302 is intending to perform based on a particular sequence of typing input motions would be only 0.5% less accurate at correctly inferring which target inputs the user 302 is intending to perform without the user 302 performing a portion of the sequence corresponding to a particular character or portion of the particular character. Based on determining that the difference in accuracy is less than a threshold error rate for suggesting the devolved sequence of typed input motions, the system may present the devolved sequence of typed input motions.

In some embodiments, the determination to present the devolved sequence to the user is made in conjunction with a separate determination that the devolved sequence of typed input motions satisfies one or more devolvement criteria (e.g., increases speed of performing the one or more target inputs that is sufficient to offset any decreased efficiency caused by the reduced accuracy).

(A10) In some embodiments of any one of A1 to A9, the AR system 300a identifies, based on the data corresponding to the sequence of typing input motions from the one or more sensors of the wearable device (e.g., the wrist-wearable device 326 or the AR device 328), a plurality of devolved sequences of typing input motions to suggest to the user for inputting the respective target input, including the devolved sequence of typed input motions (e.g., based on modifications (e.g., co-adaptions) applied to a gesture recommendation module in accordance with the user performing respective previous sequences of typing input motions). And the AR system 300a causes presentation (e.g., at the AR device 328), of a plurality of representations, each of the representations corresponding to one of the plurality of devolved sequences of typing input motions. In some embodiments, each of the plurality of devolved sequences of typing input motions is identified for suggesting to the user based on a determination that each of the respective devolved sequences satisfy one or more devolvement criteria.

(A11) In some embodiments of A10, after presenting the devolved sequence of typed input motions, the AR system 300a detects a user input, the user input corresponding to an operation for presenting alternative devolved sequences. And, responsive to the user input, the AR system 300a presents the plurality of representations, including presenting at least one of the plurality of representations corresponding to a respective devolved sequence of the plurality of devolved sequences that is different from the devolved sequence of typed input motions. For example, while the demonstration user interface elements 134 and 136 representing selectable options are being presented to the user 302 in FIG. 1C, a selection of the demonstration user interface element 136 may cause additional devolved sequences corresponding to the same target input and/or a different target input of the one or more target inputs that the user 302 performed sequences of typing input motions corresponding to in FIG. 1A. In some embodiments, the user input to present alternative devolved sequences is provided as an indication to a gesture-suggestion model (e.g., indicating that the user did not select the representation of the devolved sequence of typed input motions).

(A12) In some embodiments of any one of A1 to A11, based on the data corresponding to the sequence of typing input motions, the AR system 300a applies a co-adaptation to an input-detection model used to identify the devolved sequence of typed input motions, wherein the co-adaptation is based on user-specific aspects of performance of one or more respective typing input motions of the sequence of typing input motions. And the AR system 300a uses the co-adaptation to the input detection model to detect a different sequence of typing input motions corresponding to one or more different target inputs. In other words, a co-adaptation applied to the input detection model based on one particular sequence of typing input motions may be used during detection of a different sequence of typing input motions.

For example, the co-adapted LLM may determine that there is a specific set of characters that the input-detection model persistently detects with a lower accuracy (and/or that the user performs slower compared to other users), and the co-adapted LLM may suggest one or more devolved hand sequences to reduce inaccuracy and/or increase the user’s speed of text generation based on the user-specific aspects of the historical typing input motion sequence data related to those characters.

(A13) In some embodiments of any one of A1 to A12, after identifying the devolved sequence of typed input motions, the AR system 300a provides information about the devolved sequence of typed input motions to a generative model (e.g., an LLM, or another AI model that generates a particular medium of content). In some embodiments, the AR system 300a provides the information about the devolved sequence of typed input motions in conjunction with a conditional prompt that includes instructions for the LLM to generate a demonstration. And the AR system 300a receives, from the generative model, the representation of the devolved sequence of typed input motions (e.g., including visual and/or non-visual demonstration components). For example, a generative model may generate a textual description instructing the user 302 to perform a particular hand gesture in place of a baseline sequence of typing input motions, such as the textual element within the demonstration user interface element 134 shown in FIG. 1C stating “Type ‘th’ and then tap the space bar twice.” In some embodiments, the generative model may generate a visual animation depicting the devolved sequence of typed input motions, such as the three-dimensional plane representation shown within the demonstration user interface element 134 that illustrates the orientations of the respective typing input motions. In some embodiments, the generative model may generate an audio-based demonstration that provides spoken instructions for performing the devolved sequence of typed input motions. In some embodiments, the generative model may generate a haptic-based demonstration that causes the wrist-wearable device 326 to provide haptic feedback patterns corresponding to the timing and rhythm of the devolved sequence of typed input motions. In some embodiments, the generative model may combine multiple modalities, such as generating a visual depiction of the devolved sequence suggestion 130 shown in FIG. 1B along with accompanying textual instructions and haptic cues to guide the user 302 through learning the devolved sequence.

In some embodiments, the representation can be a demonstration to the user as to how the devolved sequence of typed input motions should be performed and this demonstration can be generated by a generative (AI) model, such as an LLM. In some embodiments, the demonstration is presented at the wearable electronic device (e.g., a wrist-wearable device). In some implementations, the demonstration is presented at a different wearable electronic device (e.g., a head-wearable device). By leveraging the generative model, the techniques described herein provide technical improvements by presenting instructions to a user by using a generative model to generate personalized instructions based on (e.g., unsupervised) learning by the model. Further, the devolved sequences of typing input motions that are suggested to the user may include sequences of typing input motions that are not predefined within any sequence library or other data storage associated with the typing input motions of the user’s available typing input motions. (A14) In some embodiments of any one of A1 to A13, the one or more sensors in operable communication with the computing system include a biopotential-signal-sensing component, and the biopotential-signal-sensing component is configured to detect hand motions performed by the user (e.g., including sequences of typing input motions). For example, the wrist-wearable device 326 shown in FIGS. 1A to 1F may be detecting the sequences of hand motions performed by the user 302, at least in part, based on data from one or more EMG sensors of the wrist-wearable device 326.

(A15) In some embodiments of A14, the devolved sequence of typed input motions includes a stationary action (e.g., a hand gesture that includes one or more neuromuscular activations but does not include any typing input motions), detected via data from the biopotential-signal-sensing component (e.g., a pinch or flexure of a finger of the user), to replace one or more typing input motions of the sequence of typing input motions associated with the one or more target inputs (e.g., the trailing vertical line of the letter “h”). In some implementations, the neuromuscular proxy can be used to cause a particular letter to be capitalized, or as a replacement for a particular common trigram (e.g., “the”).

(A16) In some embodiments of any one of A1 to A15, the sequence of typing input motions corresponding to the one or more target inputs consists of a two-dimensional movement profile (e.g., within 15 to 30 degrees of a particular defined two-dimensional plane where the user is performing the motion). The devolved sequence of typed input motions includes a typing input motion in a third dimensional plane distinct from respective planes defining the substantially two-dimensional movement profile. In some embodiments, the third dimensional plane is substantially orthogonal to a plane defined by the two-dimensional movement profile (e.g., the three-dimensional movement profile shown within the demonstration user interface element 134 in FIG. 1C). In some embodiments, attempts to perform the devolved sequence of typed input motions include hand movements within 30 degrees of the third dimensional plane. In some embodiments, the portion of the devolved sequence of typed input motions that includes movement in the third dimensional plane is estimated to increase the discriminability of the one or more target inputs. For example, suggesting a motion for the tail of “h” in the third dimensional plane may help to distinguish from a sequence of typing input motions that includes “n” by increasing the discriminability of the distinct aspect of the sequence of typing input motions for the target input.

(A17) In some embodiments of any one of A1 to A16, the AR system 300a causes storage, in a vector space, of a plurality of vector representations for respective target inputs, wherein respective vector representations of the plurality of vector representations include data profiles for sequences of typing input movements associated with the respective target inputs. And, responsive to obtaining the data corresponding to the sequence of typing input motions, the AR system 300a causes generation of a new vector representation of the sequence of typing input motions. The vector representation of the data corresponding to the sequence of typing input motions is embedded into the vector space. And based on a relationship between the new vector representation and the respective vector representations of the plurality of vector representations, a corresponding vector representation is caused to be identified (e.g., by the AR system 300a and/or a remote server in operable communication with the AR system 300a).

(A18) In some embodiments of any one of A1 to A17, while the user is performing the sequence of typing input motions, the AR system 300a presents a first dynamic user interface element including real-time data that is based on the data from the one or more sensors (e.g., a two-dimensional or three-dimensional visual representation of the motions detected based on biopotential-signal data). And the AR system 300a presents (e.g., via the AR device 328) a second dynamic user interface element including a corresponding visualization of a co-adapted performance of the sequence of typing input motions corresponding to the one or more target inputs. For example, FIGS. 1A and 1D illustrate examples where the user interface 104 is presenting a user interface element 106 that includes a visual depiction of neuromuscular activations of a hand of the user 302 while the user 302 is performing various sequences of typing input motions (e.g., the sequence of typing input motions 102). And the user interface 104 also includes the user interface element 108 that includes a visual depiction of prophetic neuromuscular activations that would be detected if the user 302 optimized their performance of the respective sequences of typing input motions 102 and 144. In some embodiments, devolved sequences of typing input motions are suggested to the user 302 based on the user performing one or more portions of sequences of typing input motions having an optimization score below a particular threshold. That is, the devolved sequences of typing input motions can be identified based on respective sequences of typing input motions that the user 302 has performed poorly.

### Concept 2. Using a generative model (e.g., an LLM) to produce instructions for performing devolved sequences of typing input motions.

(B1) FIG. 2B shows a flow chart of the example method 240 of presenting representations of identified sequences of typing input motions to a user by applying the sequences of typing input motions to a generative model that is co-adapted to a user of the computing system.

As part of performing the method 240, after identifying a devolved sequence of typed input motions based on data obtained via one or more sensors, the data corresponding to a sequence of typing input motions performed by a user associated with one or more target inputs, the AR system 300a provides (242) the information about the devolved sequence of typed input motions to a generative model. In accordance with some embodiments, the AR system 300a receives (244), from the generative model, the representation of the devolved sequence of typed input motions. For example, the input model 170 may provide the devolved sequence suggestion 130 shown in FIG. 1B and/or the devolved sequence suggestions 140 and 142 to a generative model.

After receiving the representation of the devolved sequence of typed input motions from the generative model, the AR system 300a causes (246) presentation, via the computing system, of the representation of the devolved sequence of typed input motions received from the generative model. For example, the demonstration user interface elements 134 and 136, shown in FIG. 1C, may be generated using a generative model (e.g., a generative model that includes a large language model).

(B2) In some embodiments of B1, the generative model is an LLM, and the demonstration includes a description of an aspect of the devolved sequence of typed input motions that is presented to the user (248) (e.g., the textual element within the demonstration user interface element 134, stating: “Type ‘th’ and the tap the spacebar twice”).

(B3) In some embodiments of B1, the generative model is configured to generate visual images, and the demonstration includes a non-textual visual depiction of an aspect of the devolved sequence of typed input motions (250) (e.g., the visual element within the demonstration user interface element 134 that includes the three-dimensional plane and the orientations of the respective sequences of typing input motions within the three-dimensional plane).

(B4) In some embodiments of any one of B1 to B3, the AR system 300a receives (252) an input from the user requesting a modification to the representation of the devolved sequence of typed input motions. After the AR system 300a receives the input from the user, the AR system 300a provides (254), to the generative model, a prompt based on the input from the user requesting the modification to the representation of the devolved sequence of typed input motions. The AR system 300a then receives (256), from the generative model, a different representation of the same devolved sequence of typed input motions. And the AR system 300a causes (258) presentation, via the computing system, of the different representation of the devolved sequence of typed input motions received from the generative model.

### Concept 3. Using a co-adapted AI model to teach the user of a computing system how to optimize performance of sequences of typing input motions.

(C1) FIG. 2C shows a flow chart of the example method 280 of presenting user interfaces to users that include representations of aspects of the users’ performances of sequences of typing input motions.

The operations of the method 280 are performed at a computing system (e.g., AR system 300a) that includes an AR headset configured to present AR content to a user while the computing system is detecting the user attempting to perform sequences of typing input motions (282).

In accordance with embodiments of the example method 280, the AR system 300a obtains (284), via one or more sensors of a wearable device of the computing system, data corresponding to a user attempting to perform a particular sequence of typing input motions associated with the one or more target inputs while wearing the wearable electronic device of the computing system.

And in accordance with embodiments of the example method 280, while the user 302 is performing the sequence of typing input motions, the AR system 300a presents a first user interface element corresponding to an aspect of the performance of the sequence of typing input motions, where the aspect is based on data obtained by the one or more sensors of the wearable electronic device, and presents a second user interface element that includes a visual representation of an optimal performance of the sequence of typing input motions (286).

(C2) In some embodiments of C1, after the user has completed performance of the sequence of typing input motions, the AR system 300a presents (288) another user interface element indicating a relative accuracy between the aspect of the performance of the sequence of typing input motions and the optimal performance of the sequence of typing input motions.

(C3) In some embodiments of C1 or C2, based on detecting another attempt by the user to perform the same sequence of typing input motions, the AR system 300a provides (290) an indication to the user 302 whether the other attempt to perform the same sequence of typing input motions is more accurate based on the optimal performance of the sequence of typing input motions.

(D1) A non-transitory computer-readable storage medium comprising instructions for performing operations of any one of A1 to C3.

(E1) A wearable electronic device comprising one or more processors and memory, the memory comprising instructions for performing operations of any one of A1 to C3.

(F1) A system comprising one or more processors and memory, the memory comprising instructions for performing any one of A1 to C3.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

### Example Extended-Reality Systems

FIGS. 3A, 3B, 3C-1, and 3C-2 illustrate example XR systems that include AR and MR systems, in accordance with some embodiments. FIG. 3A shows a first AR system 300a and first example user interactions using a wrist-wearable device 326, a head-wearable device (e.g., AR device 328), and/or a HIPD 342. FIG. 3B shows a second XR system 300b and second example user interactions using a wrist-wearable device 326, AR device 328, and/or an HIPD 342. FIGS. 3C-1 and 3C-2 show a third MR system 300c and third example user interactions using a wrist-wearable device 326, a head-wearable device (e.g., an MR device such as a VR device), and/or an HIPD 342. As the skilled artisan will appreciate upon reading the descriptions provided herein, the above-example AR and MR systems (described in detail below) can perform various functions and/or operations.

The wrist-wearable device 326, the head-wearable devices, and/or the HIPD 342 can communicatively couple via a network 325 (e.g., cellular, near field, Wi-Fi, personal area network, wireless LAN). Additionally, the wrist-wearable device 326, the head-wearable device, and/or the HIPD 342 can also communicatively couple with one or more servers 330, computers 340 (e.g., laptops, computers), mobile devices 350 (e.g., smartphones, tablets), and/or other electronic devices via the network 325 (e.g., cellular, near field, Wi-Fi, personal area network, wireless LAN). Similarly, a smart textile-based garment, when used, can also communicatively couple with the wrist-wearable device 326, the head-wearable device(s), the HIPD 342, the one or more servers 330, the computers 340, the mobile devices 350, and/or other electronic devices via the network 325 to provide inputs.

Turning to FIG. 3A, a user 302 is shown wearing the wrist-wearable device 326 and the AR device 328 and having the HIPD 342 on their desk. The wrist-wearable device 326, the AR device 328, and the HIPD 342 facilitate user interaction with an AR environment. In particular, as shown by the first AR system 300a, the wrist-wearable device 326, the AR device 328, and/or the HIPD 342 cause presentation of one or more avatars 304, digital representations of contacts 306, and virtual objects 308. As discussed below, the user 302 can interact with the one or more avatars 304, digital representations of the contacts 306, and virtual objects 308 via the wrist-wearable device 326, the AR device 328, and/or the HIPD 342. In addition, the user 302 is also able to directly view physical objects in the environment, such as a physical table 329, through transparent lens(es) and waveguide(s) of the AR device 328. Alternatively, an MR device could be used in place of the AR device 328 and a similar user experience can take place, but the user would not be directly viewing physical objects in the environment, such as the physical table 329, and would instead be presented with a virtual reconstruction of the physical table 329 produced from one or more sensors of the MR device (e.g., an outward facing camera capable of recording the surrounding environment).

The user 302 can use any of the wrist-wearable device 326, the AR device 328 (e.g., through physical inputs at the AR device and/or built-in motion tracking of a user’s extremities), a smart-textile garment, externally mounted extremity tracking device, the HIPD 342 to provide user inputs, etc. For example, the user 302 can perform one or more hand gestures that are detected by the wrist-wearable device 326 (e.g., using one or more EMG sensors and/or IMUs built into the wrist-wearable device) and/or AR device 328 (e.g., using one or more image sensors or cameras) to provide a user input. Alternatively, or additionally, the user 302 can provide a user input via one or more touch surfaces of the wrist-wearable device 326, the AR device 328, and/or the HIPD 342, and/or voice commands captured by a microphone of the wrist-wearable device 326, the AR device 328, and/or the HIPD 342. The wrist-wearable device 326, the AR device 328, and/or the HIPD 342 include an artificially intelligent digital assistant to help the user in providing a user input (e.g., completing a sequence of operations, suggesting different operations or commands, providing reminders, confirming a command). For example, the digital assistant can be invoked through an input occurring at the AR device 328 (e.g., via an input at a temple arm of the AR device 328). In some embodiments, the user 302 can provide a user input via one or more facial gestures and/or facial expressions. For example, cameras of the wrist-wearable device 326, the AR device 328, and/or the HIPD 342 can track the user 302’s eyes for navigating a user interface.

The wrist-wearable device 326, the AR device 328, and/or the HIPD 342 can operate alone or in conjunction to allow the user 302 to interact with the AR environment. In some embodiments, the HIPD 342 is configured to operate as a central hub or control center for the wrist-wearable device 326, the AR device 328, and/or another communicatively coupled device. For example, the user 302 can provide an input to interact with the AR environment at any of the wrist-wearable device 326, the AR device 328, and/or the HIPD 342, and the HIPD 342 can identify one or more back-end and front-end tasks to cause the performance of the requested interaction and distribute instructions to cause the performance of the one or more back-end and front-end tasks at the wrist-wearable device 326, the AR device 328, and/or the HIPD 342. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 342 can perform the back-end tasks and provide the wrist-wearable device 326 and/or the AR device 328 operational data corresponding to the performed back-end tasks such that the wrist-wearable device 326 and/or the AR device 328 can perform the front-end tasks. In this way, the HIPD 342, which has more computational resources and greater thermal headroom than the wrist-wearable device 326 and/or the AR device 328, performs computationally intensive tasks and reduces the computer resource utilization and/or power usage of the wrist-wearable device 326 and/or the AR device 328.

In the example shown by the first AR system 300a, the HIPD 342 identifies one or more back-end tasks and front-end tasks associated with a user request to initiate an AR video call with one or more other users (represented by the avatar 304 and the digital representation of the contact 306) and distributes instructions to cause the performance of the one or more back-end tasks and front-end tasks. In particular, the HIPD 342 performs back-end tasks for processing and/or rendering image data (and other data) associated with the AR video call and provides operational data associated with the performed back-end tasks to the AR device 328 such that the AR device 328 performs front-end tasks for presenting the AR video call (e.g., presenting the avatar 304 and the digital representation of the contact 306).

In some embodiments, the HIPD 342 can operate as a focal or anchor point for causing the presentation of information. This allows the user 302 to be generally aware of where information is presented. For example, as shown in the first AR system 300a, the avatar 304 and the digital representation of the contact 306 are presented above the HIPD 342. In particular, the HIPD 342 and the AR device 328 operate in conjunction to determine a location for presenting the avatar 304 and the digital representation of the contact 306. In some embodiments, information can be presented within a predetermined distance from the HIPD 342 (e.g., within five meters). For example, as shown in the first AR system 300a, virtual object 308 is presented on the desk some distance from the HIPD 342. Similar to the above example, the HIPD 342 and the AR device 328 can operate in conjunction to determine a location for presenting the virtual object 308. Alternatively, in some embodiments, presentation of information is not bound by the HIPD 342. More specifically, the avatar 304, the digital representation of the contact 306, and the virtual object 308 do not have to be presented within a predetermined distance of the HIPD 342. While an AR device 328 is described working with an HIPD, an MR headset can be interacted with in the same way as the AR device 328.

User inputs provided at the wrist-wearable device 326, the AR device 328, and/or the HIPD 342 are coordinated such that the user can use any device to initiate, continue, and/or complete an operation. For example, the user 302 can provide a user input to the AR device 328 to cause the AR device 328 to present the virtual object 308 and, while the virtual object 308 is presented by the AR device 328, the user 302 can provide one or more hand gestures via the wrist-wearable device 326 to interact and/or manipulate the virtual object 308. While an AR device 328 is described working with a wrist-wearable device 326, an MR headset can be interacted with in the same way as the AR device 328.

### Integration of Artificial Intelligence with XR Systems

FIG. 3A illustrates an interaction in which an artificially intelligent virtual assistant can assist in requests made by a user 302. The AI virtual assistant can be used to complete open-ended requests made through natural language inputs by a user 302. For example, in FIG. 3A the user 302 makes an audible request 344 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 3A also illustrates an example neural network 352 used in Artificial Intelligence applications. Uses of Artificial Intelligence (AI) are varied and encompass many different aspects of the devices and systems described herein. AI capabilities cover a diverse range of applications and deepen interactions between the user 302 and user devices (e.g., the AR device 328, an MR device 332, the HIPD 342, the wrist-wearable device 326). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems describe herein which employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 302 can interact with an AI model through natural language inputs captured by a voice sensor, text inputs, or any other input modality that accepts natural language and/or a corresponding voice sensor module. In another instance, input is provided by tracking the eye gaze of a user 302 via a gaze tracker module. Additionally, the AI model can also receive inputs beyond those supplied by a user 302. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 328) or from multiple devices that are in communication with each other (e.g., a system that includes at least two of an AR device 328, an MR device 332, the HIPD 342, the wrist-wearable device 326, etc.). The AI model can also access additional information (e.g., one or more servers 330, the computers 340, the mobile devices 350, and/or other electronic devices) via a network 325.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 328, an MR device 332, the HIPD 342, the wrist-wearable device 326) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 328, an MR device 332, the HIPD 342, the wrist-wearable device 326), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 342), haptic feedback can provide information to the user 302. An AI model can also use the inputs described above to determine the appropriate modality and device(s) to present content to the user (e.g., a user walking on a busy road can be presented with an audio output instead of a visual output to avoid distracting the user 302).

### Example Augmented Reality Interaction

FIG. 3B shows the user 302 wearing the wrist-wearable device 326 and the AR device 328 and holding the HIPD 342. In the second AR system 300b, the wrist-wearable device 326, the AR device 328, and/or the HIPD 342 are used to receive and/or provide one or more messages to a contact of the user 302. In particular, the wrist-wearable device 326, the AR device 328, and/or the HIPD 342 detect and coordinate one or more user inputs to initiate a messaging application and prepare a response to a received message via the messaging application.

In some embodiments, the user 302 initiates, via a user input, an application on the wrist-wearable device 326, the AR device 328, and/or the HIPD 342 that causes the application to initiate on at least one device. For example, in the second AR system 300b the user 302 performs a hand gesture associated with a command for initiating a messaging application (represented by messaging user interface 312); the wrist-wearable device 326 detects the hand gesture; and, based on a determination that the user 302 is wearing the AR device 328, causes the AR device 328 to present a messaging user interface 312 of the messaging application. The AR device 328 can present the messaging user interface 312 to the user 302 via its display (e.g., as shown by user 302’s field of view 310). In some embodiments, the application is initiated and can be run on the device (e.g., the wrist-wearable device 326, the AR device 328, and/or the HIPD 342) that detects the user input to initiate the application, and the device provides another device operational data to cause the presentation of the messaging application. For example, the wrist-wearable device 326 can detect the user input to initiate a messaging application, initiate and run the messaging application, and provide operational data to the AR device 328 and/or the HIPD 342 to cause presentation of the messaging application. Alternatively, the application can be initiated and run at a device other than the device that detected the user input. For example, the wrist-wearable device 326 can detect the hand gesture associated with initiating the messaging application and cause the HIPD 342 to run the messaging application and coordinate the presentation of the messaging application.

Further, the user 302 can provide a user input provided at the wrist-wearable device 326, the AR device 328, and/or the HIPD 342 to continue and/or complete an operation initiated at another device. For example, after initiating the messaging application via the wrist-wearable device 326 and while the AR device 328 presents the messaging user interface 312, the user 302 can provide an input at the HIPD 342 to prepare a response (e.g., shown by the swipe gesture performed on the HIPD 342). The user 302’s gestures performed on the HIPD 342 can be provided and/or displayed on another device. For example, the user 302’s swipe gestures performed on the HIPD 342 are displayed on a virtual keyboard of the messaging user interface 312 displayed by the AR device 328.

In some embodiments, the wrist-wearable device 326, the AR device 328, the HIPD 342, and/or other communicatively coupled devices can present one or more notifications to the user 302. The notification can be an indication of a new message, an incoming call, an application update, a status update, etc. The user 302 can select the notification via the wrist-wearable device 326, the AR device 328, or the HIPD 342 and cause presentation of an application or operation associated with the notification on at least one device. For example, the user 302 can receive a notification that a message was received at the wrist-wearable device 326, the AR device 328, the HIPD 342, and/or other communicatively coupled device and provide a user input at the wrist-wearable device 326, the AR device 328, and/or the HIPD 342 to review the notification, and the device detecting the user input can cause an application associated with the notification to be initiated and/or presented at the wrist-wearable device 326, the AR device 328, and/or the HIPD 342.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 328 can present to the user 302 game application data and the HIPD 342 can use a controller to provide inputs to the game. Similarly, the user 302 can use the wrist-wearable device 326 to initiate a camera of the AR device 328, and the user can use the wrist-wearable device 326, the AR device 328, and/or the HIPD 342 to manipulate the image capture (e.g., zoom in or out, apply filters) and capture image data.

While an AR device 328 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 3C-1 and 3C-2, the user 302 is shown wearing the wrist-wearable device 326 and an MR device 332 (e.g., a device capable of providing either an entirely VR experience or an MR experience that displays object(s) from a physical environment at a display of the device) and holding the HIPD 342. In the third AR system 300c, the wrist-wearable device 326, the MR device 332, and/or the HIPD 342 are used to interact within an MR environment, such as a VR game or other MR/VR application. While the MR device 332 presents a representation of a VR game (e.g., first MR game environment 320) to the user 302, the wrist-wearable device 326, the MR device 332, and/or the HIPD 342 detect and coordinate one or more user inputs to allow the user 302 to interact with the VR game.

In some embodiments, the user 302 can provide a user input via the wrist-wearable device 326, the MR device 332, and/or the HIPD 342 that causes an action in a corresponding MR environment. For example, the user 302 in the third MR system 300c (shown in FIG. 3C-1) raises the HIPD 342 to prepare for a swing in the first MR game environment 320. The MR device 332, responsive to the user 302 raising the HIPD 342, causes the MR representation of the user 322 to perform a similar action (e.g., raise a virtual object, such as a virtual sword 324). In some embodiments, each device uses respective sensor data and/or image data to detect the user input and provide an accurate representation of the user 302’s motion. For example, image sensors (e.g., SLAM cameras or other cameras) of the HIPD 342 can be used to detect a position of the HIPD 342 relative to the user 302’s body such that the virtual object can be positioned appropriately within the first MR game environment 320; sensor data from the wrist-wearable device 326 can be used to detect a velocity at which the user 302 raises the HIPD 342 such that the MR representation of the user 322 and the virtual sword 324 are synchronized with the user 302’s movements; and image sensors of the MR device 332 can be used to represent the user 302’s body, boundary conditions, or real-world objects within the first MR game environment 320.

In FIG. 3C-2, the user 302 performs a downward swing while holding the HIPD 342. The user 302’s downward swing is detected by the wrist-wearable device 326, the MR device 332, and/or the HIPD 342 and a corresponding action is performed in the first MR game environment 320. In some embodiments, the data captured by each device is used to improve the user’s experience within the MR environment. For example, sensor data of the wrist-wearable device 326 can be used to determine a speed and/or force at which the downward swing is performed and image sensors of the HIPD 342 and/or the MR device 332 can be used to determine a location of the swing and how it should be represented in the first MR game environment 320, which, in turn, can be used as inputs for the MR environment (e.g., game mechanics, which can use detected speed, force, locations, and/or aspects of the user 302’s actions to classify a user’s inputs (e.g., user performs a light strike, hard strike, critical strike, glancing strike, miss) or calculate an output (e.g., amount of damage)).

FIG. 3C-2 further illustrates that a portion of the physical environment is reconstructed and displayed at a display of the MR device 332 while the MR game environment 320 is being displayed. In this instance, a reconstruction of the physical environment 346 is displayed in place of a portion of the MR game environment 320 when object(s) in the physical environment are potentially in the path of the user (e.g., a collision with the user and an object in the physical environment are likely). Thus, this example MR game environment 320 includes (i) an immersive VR portion 348 (e.g., an environment that does not have a corollary counterpart in a nearby physical environment) and (ii) a reconstruction of the physical environment 346 (e.g., table 329 and the cup resting on the table). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 326, the MR device 332, and/or the HIPD 342 are described as detecting user inputs, in some embodiments, user inputs are detected at a single device (with the single device being responsible for distributing signals to the other devices for performing the user input). For example, the HIPD 342 can operate an application for generating the first MR game environment 320 and provide the MR device 332 with corresponding data for causing the presentation of the first MR game environment 320, as well as detect the user 302’s movements (while holding the HIPD 342) to cause the performance of corresponding actions within the first MR game environment 320. Additionally, or alternatively, in some embodiments, operational data (e.g., sensor data, image data, application data, device data, and/or other data) of one or more devices is provided to a single device (e.g., the HIPD 342) to process the operational data and cause respective devices to perform an action associated with processed operational data.

In some embodiments, the user 302 can wear a wrist-wearable device 326, wear an MR device 332, wear smart textile-based garments 338 (e.g., wearable haptic gloves), and/or hold an HIPD 342 device. In this embodiment, the wrist-wearable device 326, the MR device 332, and/or the smart textile-based garments 338 are used to interact within an MR environment (e.g., any AR or MR system described above in reference to FIGS. 3A-3B). While the MR device 332 presents a representation of an MR game (e.g., second MR game environment 320) to the user 302, the wrist-wearable device 326, the MR device 332, and/or the smart textile-based garments 338 detect and coordinate one or more user inputs to allow the user 302 to interact with the MR environment.

In some embodiments, the user 302 can provide a user input via the wrist-wearable device 326, an HIPD 342, the MR device 332, and/or the smart textile-based garments 338 that causes an action in a corresponding MR environment. In some embodiments, each device uses respective sensor data and/or image data to detect the user input and provide an accurate representation of the user 302’s motion. While four different input devices are shown (e.g., a wrist-wearable device 326, an MR device 332, an HIPD 342, and a smart textile-based garment 338) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 338) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 338 can be used in conjunction with an MR device and/or an HIPD 342.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium comprising instructions for:
obtaining, via one or more sensors of a wearable electronic device of a computing system, data corresponding to a user attempting to perform a sequence of keystroke gestures associated with one or more target inputs;
identifying, based on at least the data corresponding to the user attempting to perform the sequence of keystroke gestures:
a devolved sequence of keystroke gestures for inputting a respective target input of the one or more target inputs, wherein:
the devolved sequence of keystroke gestures is a different sequence as compared to the sequence of keystroke gestures, and includes fewer keystroke gestures; and
causing presentation, via the computing system, of a representation of the devolved sequence of keystroke gestures.

2. The non-transitory computer-readable storage medium of claim 1, wherein:
the identifying of the devolved sequence of keystroke gestures is performed by a trained machine-learning model, wherein:
the trained machine-learning model is trained using data obtained during performance of keystroke gestures at a physical keyboard and/or a handheld controller.

3. The non-transitory computer-readable storage medium of claim 1, further comprising instructions for:
identifying another devolved sequence of keystroke gestures to suggest to the user for inputting a different respective target input of the one or more target inputs, wherein:
the devolved sequence of keystroke gestures and the other devolved sequence of keystroke gestures, individually and collectively, include fewer keystroke gestures as compared to the sequence of keystroke gestures.

4. The non-transitory computer-readable storage medium of claim 3, wherein:
the devolved sequence of keystroke gestures and the other devolved sequence of keystroke gestures together form a multipart set of devolved sequences corresponding to the one or more target inputs; and
the multipart set of devolved sequences is selected based on comparing the multipart set of devolved sequences to the devolved sequence of keystroke gestures based on one or more devolvement criteria related to the respective sequences.

5. The non-transitory computer-readable storage medium of claim 4, wherein:
the one or more devolvement criteria include respective criteria related to:
minimizing a legibility constraint for identifying the one or more target inputs based on the devolved sequence of keystroke gestures;
reducing an amount of exertion required for performing the devolved sequence of keystroke gestures;
reducing a total number of keystroke gestures comprising the devolved sequence of keystroke gestures; and
increasing an estimated speed of producing the one or more target inputs.

6. The non-transitory computer-readable storage medium of claim 1, wherein:
the one or more sensors of the wearable electronic device include a biopotential-signal-sensing component; and
the biopotential-signal-sensing component is configured to detect hand motions performed by the user, including hand motions comprising one or more keystroke gestures.

7. The non-transitory computer-readable storage medium of claim 6, wherein:
the devolved sequence of keystroke gestures includes a stationary action, detected via data from the biopotential-signal-sensing component, to replace one or more keystroke gestures of the sequence of keystroke gestures associated with the one or more target inputs.

8. A method comprising:
obtaining, via one or more sensors of a wearable electronic device of a computing system, data corresponding to a user attempting to perform a sequence of keystroke gestures associated with one or more target inputs;
identifying, based on at least the data corresponding to the user attempting to perform the sequence of keystroke gestures:
a devolved sequence of keystroke gestures for inputting a respective target input of the one or more target inputs, wherein:
the devolved sequence of keystroke gestures is a different sequence as compared to the sequence of keystroke gestures, and includes fewer keystroke gestures; and
causing presentation, via the computing system, of a representation of the devolved sequence of keystroke gestures.

9. The method of claim 8, wherein:
the identifying of the devolved sequence of keystroke gestures is performed by a trained machine-learning model, wherein:
the trained machine-learning model is trained using data obtained during performance of keystroke gestures at a physical keyboard and/or a handheld controller.

10. The method of claim 8, further comprising:
identifying another devolved sequence of keystroke gestures to suggest to the user for inputting a different respective target input of the one or more target inputs, wherein:
the devolved sequence of keystroke gestures and the other devolved sequence of keystroke gestures, individually and collectively, include fewer keystroke gestures as compared to the sequence of keystroke gestures.

11. The method of claim 10, wherein:
the devolved sequence of keystroke gestures and the other devolved sequence of keystroke gestures together form a multipart set of devolved sequences corresponding to the one or more target inputs; and
the multipart set of devolved sequences is selected based on comparing the multipart set of devolved sequences to the devolved sequence of keystroke gestures based on one or more devolvement criteria related to the respective sequences.

12. The method of claim 11, wherein:
the one or more devolvement criteria include respective criteria related to:
minimizing a legibility constraint for identifying the one or more target inputs based on the devolved sequence of keystroke gestures;
reducing an amount of exertion required for performing the devolved sequence of keystroke gestures;
reducing a total number of keystroke gestures comprising the devolved sequence of keystroke gestures; and
increasing an estimated speed of producing the one or more target inputs.

13. The method of claim 8, wherein:
the one or more sensors of the wearable electronic device include a biopotential-signal-sensing component; and
the biopotential-signal-sensing component is configured to detect hand motions performed by the user, including hand motions comprising one or more keystroke gestures.

14. The method of claim 13, wherein:
the devolved sequence of keystroke gestures includes a stationary action, detected via data from the biopotential-signal-sensing component, to replace one or more keystroke gestures of the sequence of keystroke gestures associated with the one or more target inputs.

15. A wearable electronic device comprising one or more processors and memory storing instructions that, when executed by the one or more processors, cause the wearable electronic device to:
obtain, via one or more sensors of the wearable electronic device, data corresponding to a user attempting to perform a sequence of keystroke gestures associated with one or more target inputs;
identify, based on at least the data corresponding to the user attempting to perform the sequence of keystroke gestures:
a devolved sequence of keystroke gestures for inputting a respective target input of the one or more target inputs, wherein:
the devolved sequence of keystroke gestures is a different sequence as compared to the sequence of keystroke gestures, and includes fewer keystroke gestures; and
cause presentation of a representation of the devolved sequence of keystroke gestures.

16. The wearable electronic device of claim 15, wherein:
the identifying of the devolved sequence of keystroke gestures is performed by a trained machine-learning model, wherein:
the trained machine-learning model is trained using data obtained during performance of keystroke gestures at a physical keyboard and/or a handheld controller.

17. The wearable electronic device of claim 15, wherein the instructions further cause the wearable electronic device to:
identify another devolved sequence of keystroke gestures to suggest to the user for inputting a different respective target input of the one or more target inputs, wherein:
the devolved sequence of keystroke gestures and the other devolved sequence of keystroke gestures, individually and collectively, include fewer keystroke gestures as compared to the sequence of keystroke gestures.

18. The wearable electronic device of claim 17, wherein:
the devolved sequence of keystroke gestures and the other devolved sequence of keystroke gestures together form a multipart set of devolved sequences corresponding to the one or more target inputs; and
the multipart set of devolved sequences is selected based on comparing the multipart set of devolved sequences to the devolved sequence of keystroke gestures based on one or more devolvement criteria related to the respective sequences.

19. The wearable electronic device of claim 18, wherein:
the one or more devolvement criteria include respective criteria related to:
minimizing a legibility constraint for identifying the one or more target inputs based on the devolved sequence of keystroke gestures;
reducing an amount of exertion required for performing the devolved sequence of keystroke gestures;
reducing a total number of keystroke gestures comprising the devolved sequence of keystroke gestures; and
increasing an estimated speed of producing the one or more target inputs.

20. The wearable electronic device of claim 15, wherein:
the one or more sensors include a biopotential-signal-sensing component; and
the biopotential-signal-sensing component is configured to detect hand motions performed by the user, including hand motions comprising one or more keystroke gestures.
